(19) United States
(12) Patent Application Publication
(10) Pub. No.: US 2020/0357075 A1
(43) Pub. Date: Nov. 12, 2020

(54) SYSTEMS AND METHODS FOR MANAGING INSURANCE CONTRACTS USING TELEMATICS DATA TO BUILD A USER PROFILE

(71) Applicant: BlueOwl, LLC, San Francisco, CA (US)

(72) Inventor: Eric Dahl, Newman Lake, WA (US)

(21) Appl. No.: 16/940,951

(22) Filed: Jul. 28, 2020

Related U.S. Application Data
(63) Continuation of application No. 15/969,955, filed on May 3, 2018.
(60) Provisional application No. 62/501,908, filed on May 5, 2017.
(60) Provisional application No. 62/501,924, filed on May 5, 2017.
(60) Provisional application No. 62/501,938, filed on May 5, 2017.
(60) Provisional application No. 62/507,574, filed on May 17, 2017.
(60) Provisional application No. 62/519,401, filed on Jun. 14, 2017.
(60) Provisional application No. 62/519,443, filed on Jun. 14, 2017.
(60) Provisional application No. 62/519,456, filed on Jun. 14, 2017.
(60) Provisional application No. 62/532,722, filed on Jul. 14, 2017.

(51) Int. Cl. G06Q 40/08; G06F 16/27

(52) U.S. Cl. CPC G06Q 40/08; G06F 16/27

(57) ABSTRACT

A system for managing insurance contracts is configured to (i) store a user profile of a user and a current user insurance contract associated with the user, the user profile including user preferences, (ii) access telematics data associated with the user, (iii) based upon the telematics data, generate a usage profile associated with the user, the usage profile including usage characteristics, (iv) associate the usage profile with the user profile, (v) receive offers for insurance contracts from a plurality of insurance providers, wherein each of the offers includes coverage options and target usage characteristics, (vi) for each of the offers, compare the corresponding coverage options to the user preferences and the target usage characteristics to the usage characteristics associated with the user, (vii) automatically determine a desired offer based upon the comparison, and (viii) electronically update the current user insurance contract based upon the desired offer.

### CROSS-REFERENCE TO RELATED APPLICATIONS

This application claims the benefit of priority to U.S. Provisional Patent Application No. 62/501,908, filed May 5, 2017, entitled “SYSTEMS AND METHODS FOR MANAGING INSURANCE CONTRACTS,” US. Provisional Patent Application No. 62/501,924, filed May 5, 2017, entitled “SYSTEMS AND METHODS FOR MANAGING INSURANCE CONTRACTS USING TELEMATICS DATA TO BUILD A USER PROFILE,” U.S. Provisional Patent Application No. 62/501,938, filed May 5, 2017, entitled “SYSTEMS AND METHODS FOR MANAGING INSURANCE CONTRACTS USING TELEMATICS DATA,” U.S. Provisional Patent Application No. 62/507,574, filed May 17, 2017, entitled “SYSTEMS AND METHODS FOR MANAGING INSURANCE CONTRACTS USING GAME-BASED TELEMATICS DATA,” and U.S. Provisional Patent Application No. 62/519,401, filed Jun. 14, 2017, entitled “SYSTEMS AND METHODS FOR MANAGING INSURANCE CONTRACTS,” and U.S. Provisional Patent Application No. 62/519,443, filed Jun. 14, 2017, entitled “SYSTEMS AND METHODS FOR MANAGING INSURANCE CONTRACTS USING TELEMATICS DATA TO BUILD A USER PROFILE,” and U.S. Provisional Patent Application No. 62/519,456, filed Jun. 14, 2017, entitled “SYSTEMS AND METHODS FOR MANAGING INSURANCE CONTRACTS USING TELEMATICS DATA,” and U.S. Provisional Patent Application No. 62/532,722, filed Jul. 14, 2017, entitled “SYSTEMS AND METHODS FOR MANAGING INSURANCE CONTRACTS USING GAME-BASED TELEMATICS DATA,” the entire contents and disclosures of which are hereby incorporated by reference herein in their entirety.

### FIELD OF THE INVENTION

The present disclosure relates to managing insurance contracts and, more particularly, to a network-based system and method for managing and updating user insurance contracts based upon user preferences, and using telematics data to build a user profile.

### BACKGROUND

There are numerous insurance companies and insurance marketplaces. In both realms, consumers have an ongoing worry about whether or not they are getting the right coverage at the best possible price. In both of these cases, it may primarily be the consumer's responsibility to do the research, find better options, evaluate those options, and then switch from one plan and/or insurer to another. Conventional techniques may have other drawbacks as well.

### BRIEF SUMMARY

The present embodiments may relate to systems and methods for managing insurance contracts. The platform may include an insurance management (“IM”) computer system, a plurality of insurance provider computer systems, a plurality of user computer devices, and/or at least one telematics computer system associated with a vehicle and/or a residence. The IM computer system may be a server device associated with an insurance broker or a third party independent of a plurality of insurance providers.

In one aspect, a computer system for managing insurance contracts may be provided. The computer system may include at least one processor in communication with at least one memory device. The at least one processor may be programmed to store a user profile and a current user insurance contract. The user profile may include a plurality of user preferences. The at least one processor may also be programmed to receive a plurality of offers for insurance contracts from a plurality of insurance providers. Each of the plurality of offers may include a plurality of coverage options. The at least one processor may further be programmed to compare the corresponding plurality of coverage options to the plurality of user preferences for each of the plurality of offers, automatically determine a desired offer of the plurality of offers based upon the comparison, and/or electronically update the current user insurance contract based upon the desired offer to facilitate providing the user with the best insurance contract available based upon the user's preferences. The computer system may have additional, less, or alternate functionality, including that discussed elsewhere herein.

In another aspect, a computer-based method for managing insurance contracts may be provided. The method may be implemented on an insurance management (“IM”) computer device including at least one processor in communication with at least one memory device. The method may include storing, in the memory device, a user profile and a current user insurance contract. The user profile may include a plurality of user preferences. The method may also include receiving, at the IM computer device, a plurality of offers for insurance contracts from a plurality of insurance providers. Each of the plurality of offers may include a plurality of coverage options. The method may further include comparing, by the IM computer device, the corresponding plurality of coverage options to the plurality of user preferences for each of the plurality of offers, automatically determining a desired offer of the plurality of offers based upon the comparison, and electronically updating, by the IM computer device the current user insurance contract based upon the desired offer to facilitate providing the user with the best insurance contract available based upon the user's preferences. The method may have additional, less, or alternate functionality, including that discussed elsewhere herein.

In yet another aspect, at least one non-transitory computer-readable storage media having computer-executable instructions embodied thereon may be provided. When executed by at least one processor, the computer-executable instructions may cause the processor to store a user profile and a current user insurance contract. The user profile may include a plurality of user preferences. The computer-executable instructions may also cause the processor to receive a plurality of offers for insurance contracts from a plurality of insurance providers. Each of the plurality of offers may include a plurality of coverage options. The computer-executable instructions may also cause the processor to compare the corresponding plurality of coverage options to the plurality of user preferences for each of the plurality of offers, automatically determine a desired offer of the plurality of offers based upon the comparison, and/or electronically update the current user insurance contract based upon the desired offer to facilitate providing the user with the best insurance contract available based upon the user's preferences. The storage media may have additional, less, or alternate functionality, including that discussed elsewhere herein.

In a further aspect, a computer system for managing insurance contracts and using telematics data to build a user profile may be provided. The computer system may include at least one processor in communication with at least one memory device. The at least one processor may be programmed to store a user profile of a user and a current user insurance contract associated with the user. The user profile may include a plurality of user preferences. The at least one processor may also be programmed to access telematics data associated with the user, and based upon the telematics data, generate a usage profile associated with the user. The usage profile may include one or more usage characteristics. The at least one processor may also be programmed to associate the generated usage profile with the user profile. The at least one processor may also be programmed to receive a plurality of offers for insurance contracts from a plurality of insurance providers. Each of the plurality of offers may include a plurality of coverage options and one or more target usage characteristics. For each of the plurality of offers, the at least one processor may be programmed to compare the corresponding plurality of coverage options to the plurality of user preferences and the one or more target usage characteristics to the one or more usage characteristics associated with the user. The at least one processor may be further programmed to automatically determine a desired offer of the plurality of offers based upon the comparison, and electronically update the current user insurance contract based upon the desired offer. The computer system may have additional, less, or alternate functionality, including that discussed elsewhere herein.

In yet another aspect, a computer-based method for managing insurance contracts using telematics data to build a user profile may be provided. The method may be implemented on an insurance management (“TM”) computer device including at least one processor in communication with at least one memory device. The method may include storing, in the memory device, the user profile of a user and a current user insurance contract associated with the user. The user profile may include a plurality of user preferences. The method may further include accessing telematics data associated with the user, and based upon the telematics data, generating a usage profile associated with the user, the usage profile including one or more usage characteristics. The method may also include associating the generated usage profile with the user profile. The method may include receiving a plurality of offers for insurance contracts from a plurality of insurance providers. Each of the plurality of offers may include a plurality of coverage options and one or more target usage characteristics. The method may also include, for each of the plurality of offers, comparing the corresponding plurality of coverage options to the plurality of user preferences and the one or more target usage characteristics to the one or more usage characteristics associated with the user. The method may still further include automatically determining a desired offer of the plurality of offers based upon the comparison, and electronically updating the current user insurance contract based upon the desired offer. The method may have additional, less, or alternate functionality, including that discussed elsewhere herein.

In a further aspect, at least one non-transitory computer-readable storage medium having computer-executable instructions embodied thereon may be provided. When executed by at least one processor, the computer-executable instructions may cause the processor to store a user profile of a user and a current user insurance contract associated with the user. The user profile may include a plurality of user preferences. The computer-executable instructions may also cause the processor to access telematics data associated with the user, and based upon the telematics data, generate a usage profile associated with the user, the usage profile including one or more usage characteristics. The computer-executable instructions may also cause the processor to associate the generated usage profile with the user profile. The computer-executable instructions may further cause the processor to receive a plurality of offers for insurance contracts from a plurality of insurance providers. Each of the plurality of offers may include a plurality of coverage options and one or more target usage characteristics. The computer-executable instructions may also cause the processor to, for each of the plurality of offers, compare the corresponding plurality of coverage options to the plurality of user preferences and the one or more target usage characteristics to the one or more usage characteristics associated with the user. The computer-executable instructions may still further cause the processor to automatically determine a desired offer of the plurality of offers based upon the comparison, and electronically update the current user insurance contract based upon the desired offer. The storage media may have additional, less, or alternate functionality, including that discussed elsewhere herein.

In still another aspect, a computer system for managing insurance contracts may be provided. The computer system may include at least one processor in communication with at least one memory device. The at least one processor may be programmed to store a user profile of a user and a current user insurance contract associated with the user. The user profile may include a plurality of user preferences and a usage profile including one or more usage characteristics. The at least one processor may also be programmed to receive a plurality of offers for insurance contracts from a plurality of insurance providers. Each of the plurality of offers may include a plurality of coverage options, one or more target usage characteristics, and one or more prices associated with the one or more target usage characteristics. For each of the plurality of offers, the at least one processor may also be programmed to compare the corresponding plurality of coverage options to the plurality of user preferences, and the one or more target usage characteristics to the one or more usage characteristics associated with the user. Moreover, the at least one processor may be programmed to automatically determine a plurality of acceptable offers based upon the plurality of offers and the comparison, automatically determine a desired offer of the plurality of acceptable offers based upon the one or more prices associated with each of the plurality of acceptable offers, and electronically update the current user insurance contract based upon the desired offer. The computer system may have additional, less, or alternate functionality, including that discussed elsewhere herein.

In yet another aspect, a computer-based method for managing insurance contracts using telematics data to build a user profile may be provided. The method may be implemented on an insurance management (“IM”) computer device including at least one processor in communication with at least one memory device. The method may include storing, in the memory device, the user profile of a user and a current user insurance contract associated with the user. The user profile may include a plurality of user preferences and a usage profile including one or more usage characteristics. The method may also include receiving a plurality of offers for insurance contracts from a plurality of insurance providers. Each of the plurality of offers may include a plurality of coverage options, one or more target usage characteristics, and one or more prices associated with the one or more target usage characteristics. For each of the plurality of offers, the method may further include comparing the corresponding plurality of coverage options to the plurality of user preferences, and the one or more target usage characteristics to the one or more usage characteristics associated with the user. Moreover, the method may include automatically determining a plurality of acceptable offers based upon the plurality of offers and the comparison, automatically determining a desired offer of the plurality of acceptable offers based upon the one or more prices associated with each of the plurality of acceptable offers, and electronically updating the current user insurance contract based upon the desired offer. The method may have additional, less, or alternate functionality, including that discussed elsewhere herein.

In a further aspect, at least one non-transitory computer-readable storage medium having computer-executable instructions embodied thereon may be provided. When executed by at least one processor, the computer-executable instructions may cause the processor to store a user profile of a user and a current user insurance contract associated with the user. The user profile includes a plurality of user preferences and a usage profile including one or more usage characteristics. The computer-executable instructions may also cause the processor to receive a plurality of offers for insurance contracts from a plurality of insurance providers. Each of the plurality of offers includes a plurality of coverage options, one or more target usage characteristics, and one or more prices associated with the one or more target usage characteristics. For each of the plurality of offers, the computer-executable instructions may further cause the processor to compare the corresponding plurality of coverage options to the plurality of user preferences, and the one or more target usage characteristics to the one or more usage characteristics associated with the user. Moreover, the computer-executable instructions may cause the processor to automatically determine a plurality of acceptable offers based upon the plurality of offers and the comparison, automatically determine a desired offer of the plurality of acceptable offers based upon the one or more prices associated with each of the plurality of acceptable offers, and electronically update the current user insurance contract based upon the desired offer. The storage media may have additional, less, or alternate functionality, including that discussed elsewhere herein.

In still another aspect, a computer system for using game-based telematics data to generate a usage profile for a user may be provided. The computer system may include at least one processor in communication with at least one memory device. The at least one processor may be programmed to store a user game profile of a user. The user game profile may be associated with a telematics-based game. The at least one processor may also be programmed to access telematics data associated with the user based upon a vehicular trip, automatically determine one or more game resources earned by the user during the vehicular trip based upon the telematics data, electronically update the user game profile based upon the one or more game resources, and determine a vehicular usage profile based upon the user game profile. The computer system may have additional, less, or alternate functionality, including that discussed elsewhere herein.

In yet another aspect, a computer-based method for using game-based telematics data to generate a usage profile for a user may be provided. The method may be implemented on a computer device including at least one processor in communication with at least one memory device. The method may include storing, in the memory device, a user game profile of a user. The user game profile may be associated with at least one telematics-based game. The method may also include accessing telematics data associated with the user based upon a vehicular trip, automatically determining one or more game resources earned by the user during the vehicular trip based upon the telematics data, associating the generated usage profile with the user profile, electronically updating the user game profile based upon the one or more game resources, and determining a vehicular usage profile based upon the user game profile. The method may have additional, less, or alternate functionality, including that discussed elsewhere herein.

In a further aspect, at least one non-transitory computer-readable storage medium having computer-executable instructions embodied thereon may be provided. When executed by at least one processor, the computer-executable instructions may cause the processor to store a user game profile of a user. The user game profile may be associated with at least one telematics-based game. The computer-executable instructions may also cause the processor to access telematics data associated with the user based upon a vehicular trip, automatically determine one or more game resources earned by the user during the vehicular trip based upon the telematics data, electronically update the user game profile based upon the one or more game resources, and determine a vehicular usage profile based upon the user game profile. The storage media may have additional, less, or alternate functionality, including that discussed elsewhere herein.

In another aspect, a computer system for managing insurance contracts may be provided. The computer system may include at least one processor in communication with at least one memory device. The at least one processor may be programmed to store a user profile and a current user insurance contract. The user profile may include a plurality of user preferences. The user profile and the current user insurance contract may be stored in a blockchain structure. The at least one processor may also be programmed to receive a plurality of offers for insurance contracts from a plurality of insurance providers. Each of the plurality of offers may include a plurality of coverage options. The at least one processor may further be programmed to compare the corresponding plurality of coverage options to the plurality of user preferences for each of the plurality of offers, automatically determine a desired offer of the plurality of offers based upon the comparison, electronically update the current user insurance contract based upon the desired offer to facilitate providing the user with the best insurance contract available based upon the user's preferences, and store the updated current user insurance contract in a new block in the current user insurance contract blockchain. The computer system may have additional, less, or alternate functionality, including that discussed elsewhere herein.

In another aspect, a computer-based method for managing insurance contracts may be provided. The method may be implemented on an insurance management (“IM”) computer device including at least one processor in communication with at least one memory device. The method may include storing, in the memory device, a user profile and a current user insurance contract. The user profile may include a plurality of user preferences. The user profile and the current user insurance contract may be stored in a blockchain structure. The method may also include receiving, at the IM computer device, a plurality of offers for insurance contracts from a plurality of insurance providers. Each of the plurality of offers may include a plurality of coverage options. The method may further include comparing, by the IM computer device, the corresponding plurality of coverage options to the plurality of user preferences for each of the plurality of offers, automatically determining a desired offer of the plurality of offers based upon the comparison, electronically updating, by the IM computer device the current user insurance contract based upon the desired offer to facilitate providing the user with the best insurance contract available based upon the user's preferences, and/or storing the updated current user insurance contract in a new block in the current user insurance contract blockchain. The method may have additional, less, or alternate functionality, including that discussed elsewhere herein.

In yet another aspect, at least one non-transitory computer-readable storage media having computer-executable instructions embodied thereon may be provided. When executed by at least one processor, the computer-executable instructions may cause the processor to store a user profile and a current user insurance contract. The user profile may include a plurality of user preferences. The user profile and the current user insurance contract may be stored in a blockchain structure. The computer-executable instructions may also cause the processor to receive a plurality of offers for insurance contracts from a plurality of insurance providers. Each of the plurality of offers may include a plurality of coverage options. The computer-executable instructions may also cause the processor to compare the corresponding plurality of coverage options to the plurality of user preferences for each of the plurality of offers, automatically determine a desired offer of the plurality of offers based upon the comparison, electronically update the current user insurance contract based upon the desired offer to facilitate providing the user with the best insurance contract available based upon the user's preferences, and/or store the updated current user insurance contract in a new block in the current user insurance contract blockchain. The storage media may have additional, less, or alternate functionality, including that discussed elsewhere herein.

In a further aspect, a computer system for managing insurance contracts and using telematics data to build a user profile may be provided. The computer system may include at least one processor in communication with at least one memory device. The at least one processor may be programmed to store a user profile of a user and a current user insurance contract associated with the user. The user profile may include a plurality of user preferences. The user profile and the current user insurance contract may be stored in a blockchain structure. The at least one processor may also be programmed to access telematics data associated with the user, and based upon the telematics data, generate a usage profile associated with the user. The usage profile may include one or more usage characteristics. The at least one processor may also be programmed to associate the generated usage profile with the user profile and store the usage profile in a block in the current user insurance contract blockchain. The at least one processor may also be programmed to receive a plurality of offers for insurance contracts from a plurality of insurance providers. Each of the plurality of offers may include a plurality of coverage options and one or more target usage characteristics. For each of the plurality of offers, the at least one processor may be programmed to compare the corresponding plurality of coverage options to the plurality of user preferences and the one or more target usage characteristics to the one or more usage characteristics associated with the user. The at least one processor may be further programmed to automatically determine a desired offer of the plurality of offers based upon the comparison, and electronically update the current user insurance contract based upon the desired offer. Moreover, the at least one processor may be programmed to store the updated current user insurance contract in a new block in the current user insurance contract blockchain. The computer system may have additional, less, or alternate functionality, including that discussed elsewhere herein.

In yet another aspect, a computer-based method for managing insurance contracts using telematics data to build a user profile may be provided. The method may be implemented on an insurance management (“IM”) computer device including at least one processor in communication with at least one memory device. The method may include storing, in the memory device, the user profile of a user and a current user insurance contract associated with the user. The user profile may include a plurality of user preferences. The user profile and the current user insurance contract may be stored in a blockchain structure. The method may further include accessing telematics data associated with the user, and based upon the telematics data, generating a usage profile associated with the user, the usage profile including one or more usage characteristics. The method may also include associating the generated usage profile with the user profile and storing the usage profile in a block in the current user insurance contract blockchain. The method may include receiving a plurality of offers for insurance contracts from a plurality of insurance providers. Each of the plurality of offers may include a plurality of coverage options and one or more target usage characteristics. The method may also include, for each of the plurality of offers, comparing the corresponding plurality of coverage options to the plurality of user preferences and the one or more target usage characteristics to the one or more usage characteristics associated with the user. The method may still further include automatically determining a desired offer of the plurality of offers based upon the comparison, electronically updating the current user insurance contract based upon the desired offer, and storing the updated current user insurance contract in a new block in the current user insurance contract blockchain. The method may have additional, less, or alternate functionality, including that discussed elsewhere herein.

In a further aspect, at least one non-transitory computer-readable storage medium having computer-executable instructions embodied thereon may be provided. When executed by at least one processor, the computer-executable instructions may cause the processor to store a user profile of a user and a current user insurance contract associated with the user. The user profile may include a plurality of user preferences. The user profile and the current user insurance contract may be stored in a blockchain structure. The computer-executable instructions may also cause the processor to access telematics data associated with the user, and based upon the telematics data, generate a usage profile associated with the user, the usage profile including one or more usage characteristics. The computer-executable instructions may also cause the processor to associate the generated usage profile with the user profile and store the usage profile in a block in the current user insurance contract blockchain. The computer-executable instructions may further cause the processor to receive a plurality of offers for insurance contracts from a plurality of insurance providers. Each of the plurality of offers may include a plurality of coverage options and one or more target usage characteristics. The computer-executable instructions may also cause the processor to, for each of the plurality of offers, compare the corresponding plurality of coverage options to the plurality of user preferences and the one or more target usage characteristics to the one or more usage characteristics associated with the user. The computer-executable instructions may still further cause the processor to automatically determine a desired offer of the plurality of offers based upon the comparison, electronically update the current user insurance contract based upon the desired offer, and store the updated current user insurance contract in a new block in the current user insurance contract blockchain. The storage media may have additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a flow chart of an exemplary process of managing and updating user insurance contracts based upon user preferences;

FIG. 2 illustrates a flow chart of an exemplary computer-implemented process for managing and updating user insurance contracts based upon user preferences as shown in FIG. 1;

FIG. 3 illustrates a simplified block diagram of an exemplary computer system for implementing the process shown in FIG. 1 and the process shown in FIG. 2;

FIG. 4 illustrates an exemplary configuration of a client computer device, in accordance with one embodiment of the present disclosure;

FIG. 5 illustrates an exemplary configuration of a server system, in accordance with one embodiment of the present disclosure;

FIG. 6 illustrates a diagram of components of one or more exemplary computing devices that may be used in the system shown in FIG. 1 and the system shown in FIG. 3;

FIG. 7 illustrates a schematic diagram of an exemplary telematics computer device that may be used for implementing the process shown in FIG. 1 and the process shown in FIG. 8, embodied as a vehicle including a vehicle controller;

FIG. 8 illustrates a flow chart of an exemplary computer-implemented process for managing and updating user insurance contracts based upon user preferences and using telematics data to build a user profile;

FIG. 9 illustrates a schematic diagram of another exemplary process for matching the users to insurance providers based upon user profiles and insurer bids using the system shown in FIG. 3;

FIG. 10 illustrates a flow diagram of an exemplary process of matching users to insurance providers based upon user profiles and insurer bids as shown in FIG. 9 using the system shown in FIG. 3;

FIG. 11 illustrates a flow chart of an exemplary computer-implemented process for matching the users to insurance providers based upon user profiles and insurer offers;

FIG. 12 illustrates a flow diagram of an exemplary computer-implemented process for using game-based telematics data to generate a usage profile for a user using the system shown in FIG. 3; and

FIG. 13 illustrates a flow chart of an exemplary computer-implemented process for using game-based telematics data to generate a usage profile for a user using the process shown in FIG. 12.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alfa, systems and methods for managing and updating insurance contracts. In one exemplary embodiment, the methods may be performed by an insurance management (“IM”) computer device that is independent of an individual insurance provider, also known as an insurance management (“IM”) server.

In the exemplary embodiment, the IM server may store a user profile and a current user insurance contract. The user profile may include a plurality of user preferences, and the current user insurance contract may include a plurality of coverage options. In the exemplary embodiment, the IM server may receive the user profile from a user computer device (e.g., a user computer device associated with and/or operated by an insurance user or consumer).

In the exemplary embodiment, the IM server may receive a plurality of offers from a plurality of insurance provider computer devices, which are associated with insurance providers. Each of the offers may include a plurality of coverage options, where each of the coverage options represents one or more details about an insurance contract associated with the offer. For each of the plurality of offers, the IM server may compare the corresponding plurality of coverage options to the corresponding plurality of user preferences in the user profile.

The IM server may determine a desired offer of the plurality of offers based upon the comparison. As described further herein, the desired offer may represent an offer that (i) best meets one or more criteria associated with the corresponding insurance provider computer device, (ii) best meets one or more criteria associated with a user (e.g., a lowest price or highest coverage offer), and/or (iii) represents a compromise between the criteria of the insurance provider computing device and the user. In some embodiments, the IM server may transmit the desired offer to the user computer device for the user's approval. Once the IM server receives the user's approval, the IM server may update the current user insurance contract based upon the desired offer. In some further embodiments, the IM server may determine a plurality of desired offers. In these embodiments, the IM server may transmit the plurality of desired offers to the user computer device. The user may select one of the plurality of desired offers and transmit that selection to the IM server. The IM server may update the current user insurance contract based upon that selection.

In the exemplary embodiment, the IM server may update the current user insurance contract based upon the desired offer. The IM server may transmit approval of the desired offer to the insurance provider computer device including payment and other information from the user profile to put the desired offer in force as the current user insurance contract.

In some embodiments, the plurality of user preferences in the user profile may include a plurality of ratings, where the user has rated the importance of different coverage options. In these embodiments, the IM server may compare the plurality of ratings to the plurality of coverage options for each of the plurality of offers. The IM server may determine a ranking for each of the plurality of offers based upon the corresponding comparisons. For example, the IM server may determine that a first offer ranks higher than a second offer based upon how closely the first offer aligns with the user preferences in comparison to how the second offer aligns with the user preferences. In these embodiments, the IM server may determine the desired offer based upon the rankings. For example, the IM server may determine that the highest ranked offer is the desired offer.

In some further embodiments, the IM server may rank the current user insurance contract with the ranked plurality of offers. If the current user insurance contract ranks higher than any of the plurality of offers, the IM server may take no further action until there is a change in either the plurality of offers or the user profile. If one or more offers rank higher than the current user insurance contract, the IM server may transmit those offers to the user computer device for the user's review. In still other embodiments, the IM server may update the current user insurance contract based upon the highest ranked offer, where the highest ranked offer is ranked higher than the current user insurance contract.

In some embodiments, the IM server may store the plurality of offers. In these embodiments, the IM server may receive additional offers from one or more insurance provider computer devices. In these embodiments, IM server may update the stored plurality of offers based upon the additional offers.

In some embodiments, the user may sign up for an insurance management service from the IM server. In these embodiments, the IM server may request that the user provide a plurality of user preferences about insurance coverage options for a desired insurance contract. The IM server may transmit a plurality of questions and/or a survey to the user computer device for the user to fill out. The IM server may generate the user profile based upon the user's answers.

In some further embodiments, the IM server may determine a first current user insurance contract based upon the plurality of offers and the user profile. In these embodiments, the IM server may determine one or more offers of the plurality of offers based upon the user profile. The IM server may transmit one or more of these offers to the user computer device for the user to choose. Once the IM server receives approval of one of the offers, the IM server may store the approved offer as the current user insurance contract. In these embodiments, the IM server may generate or set up the current user insurance contract.

In some embodiments, the IM server may be configured to perform the steps of the above process on a periodic basis, such as once a month. In some cases, the IM server may not find an offer that is better than the current user insurance contract. In these situations, the IM server may notify the user that current user insurance contract is currently the best available insurance contract.

At least one of the technical problems solutions provided by this system may include: (i) improving speed and accuracy of issuing an insurance policy; (ii) determining an optimum insurance policy for a user based upon the user's preferences; (iii) updating a user's insurance policy on a regular basis based upon changes in insurance offerings; (iv) constantly reviewing a user's insurance policy to ensure that it is up to date; and/or (v) providing the option for the user to change insurance policies based upon the user's provided preferences.

The methods and systems described herein may be implemented using computer programming or engineering techniques including computer software, firmware, hardware, or any combination or subset thereof, wherein the technical effects may be achieved by performing at least one of the following steps: (a) store a user profile and a current user insurance contract, where the user profile includes a plurality of user preferences, and where the plurality of user preferences include a plurality of ratings for a plurality of potential coverage options; (b) receive a plurality of offers for insurance contracts, wherein each of the plurality of offers includes a plurality of coverage options; (c) for each of the plurality of offers, compare the corresponding plurality of coverage options to the plurality of user preferences; (d) compare the plurality of ratings to the plurality of coverage options for each of the plurality of offers; (e) determine a ranking for each of the plurality of offers based upon the corresponding comparisons; (f) determine a desired offer of the plurality of offers based upon the comparison and the corresponding ranking; (e) transmit the desired offer to the user; (g) receive approval of the desired offer from the user; and (h) update the current user insurance contract based upon the desired offer.

### Exemplary Process for Managing Usage-Based Insurance

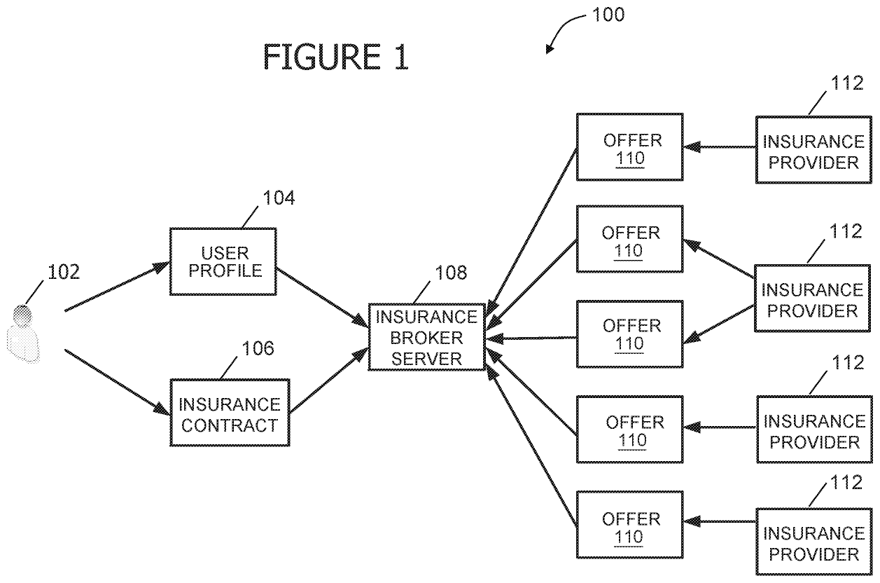

FIG. 1 illustrates a flow chart of an exemplary computer-implemented process 100 for managing and updating insurance contracts based upon user preferences.

In the exemplary embodiment, a user 102 may provide a user profile 104 and an insurance contract 106 to an insurance broker server 108. In the exemplary embodiment, user profile 104 may include a plurality of user preferences about coverage options for an insurance contract. User profile 104 may include number, name(s), gender(s), and age(s) of one or more individual(s) to be covered. Other user preferences may include, but are not limited to, current medical conditions, deductible limits, maximum per-visit fees, minimum coverage amounts, maximum premiums, and user location. In the exemplary embodiment, insurance contract 106 may be for, but is not limited to, home insurance, renter's insurance, vehicle insurance, trip insurance, health insurance, life insurance, long term and/or short term disability insurance, cyber insurance, business insurance, usage-based insurance, and/or any other type of insurance. In the exemplary embodiment, insurance contract 106 is currently covering user 102. In some further embodiments, the plurality of user preferences may also include ratings of how important different coverage options are to the associated user 102. For example, user 102 may rate a maximum deductible amount very low in comparison to an annual coverage amount. In addition, in some embodiments, as described further herein, user profile 104 may include a usage profile. The usage profile includes one or more usage characteristics that describe usage of an object or property associated with user 102 for which user 102 is seeking insurance coverage.

In some embodiments, user 102 may not have an active insurance contract 106 when user 102 sets up user profile 104 with broker server 108. In these embodiments, broker server 108 may receive user profile 104 from user 102. Broker server 108 may compare the plurality of coverage options in a plurality of offers 110 to determine a desired offer 110 for user 102. In these embodiments, broker server 108 may compare the coverage options of each of the plurality of offers 110 to determine the best match with the plurality of user preferences in user profile 104. In some embodiments, broker server 108 may transmit the offer 110 that is the best match between coverage options and user preferences to user 102. In other embodiments, broker server 108 may transmit a plurality of offers 110 that are acceptable matches for user 102 to choose between. Once user 102 selects an offer 110, broker server 108 may facilitate setting user 102 up with an insurance contract 106 based upon the selected offer 110.

In the exemplary embodiment, when broker server 108 has stored both user profile 104 and insurance contract 106, broker server 108 may receive a plurality of offers 110 for insurance contracts from a plurality of insurance providers 112. In the exemplary embodiment, each insurance provider 112 may transmit information about one or more offers 110 to broker server 108. In other embodiments, broker server 108 may request information about offers 110 from computer devices associated with insurance providers 112. In still other embodiments, broker server 108 may crawl and/or query websites associated with insurance provider 112 to retrieve information about offers 110. Each offer 110 may include information about the coverage options associated with offer 110, such as, but not limited to, premium amount, switching conditions, deductible limits, maximum per-visit fees, minimum coverage amounts, maximum premiums, coverage limitations, and/or location limitations and/or restrictions. In addition, in some embodiments, each offer 110 may include one or more target usage characteristics. Target usage characteristics may define targets or limits of usage of the object or property covered under the insurance contract. For instance, target usage characteristics may be associated with risk or risky behaviors that the corresponding insurance provider 112 may tolerate within the bounds of that offer 110. For instance, one offer 110 for vehicle insurance that has a relatively low premium and particular coverage options may include target usage characteristics that limit risk/risky behaviors, such as a limit on average distance driven per period of time or a defined threshold or range associated with sudden braking. However another offer 110 by the same insurance provider 112 may have a relatively higher premium and the same or different coverage options, but may also have higher limits on or wider ranges of target usage characteristics. Target usage characteristics may be distinguished from coverage options in that coverage options may describe the insurance offer 110 or contract associated therewith, whereas target usage characteristics may describe the particular user 102 that may be covered thereby.

In some further embodiments, each offer 110 may include one or more prices associated with the individual target usage characteristics. In some of these embodiments, the price is a maximum that the associated insurance provider 112 is willing to pay to be matched with users 102 that have the desired target usage characteristics. In some further embodiments, the price may include a range or plurality of prices for different levels of the target usage characteristic. For example, if the target usage characteristic is a risky behavior, the offer 110 may include a first price for individuals that rank very low on the risky behavior, and a second price for individuals that rank higher on the risky behavior characteristic. In some of these embodiments, there may be a plurality of rankings for each target usage characteristic and the offer 110 may include a plurality of prices for each of the plurality of rankings. Furthermore, the price may also include a budget, which is the maximum amount that insurance provider 112 is willing to pay for profiles associated with the desired target usage characteristics. In some embodiments, this budget is for a predetermined period of time, such as a week, a month, a quarter, and/or a year. In some still further embodiments, the prices may be for specific attributes of users and/or a combination of user attributes and target user characteristics.

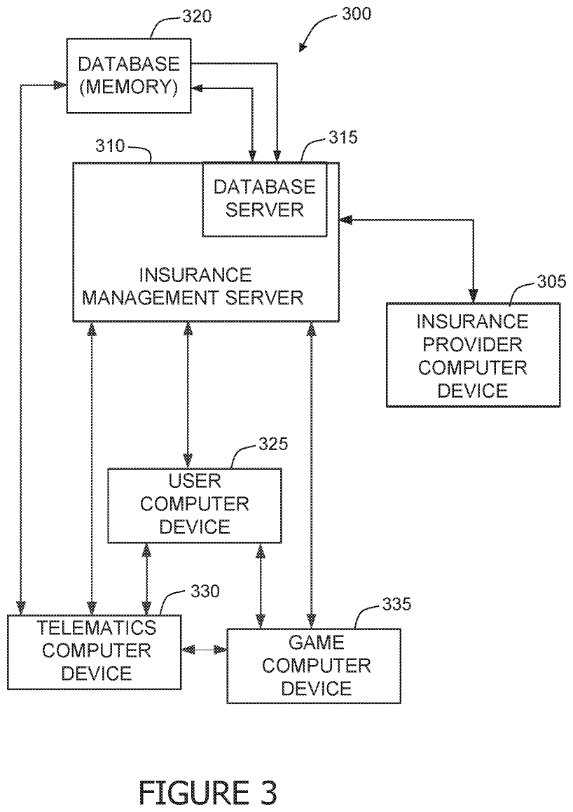

In some embodiments, the insurance provider 112 associated with the offer 110 pays the actual price to the IM server 310 (shown in FIG. 3) for each user profile 104. In other embodiments, the actual price is paid to a third party for each user profile 104.

In the exemplary embodiment, broker server 108 may compare each of the plurality of offers 110 to user profile 104. Accordingly, broker server 108 may analyze each of the coverage options in comparison to the corresponding user preferences in user profile 104. In some embodiment, broker server 108 may analyze each of the target usage characteristics of an offer 110 in comparison to the usage characteristics of user 102 in user profile 104. In some embodiments, broker server 108 may assign each of the coverage options a rating based upon the details of that coverage option in comparison to the corresponding user preferences and/or usage characteristics. In some other embodiments, broker server 108 may rank the coverage options of the offers 110, both in comparison to each other and in comparison to the coverage options of user profile 104.

Then insurance broker server 108 may compare the coverage options of offers 110 in comparison to the user's current insurance contract 106. If broker server 108 considers one or more of the plurality of offers 110 to be an improvement over the current insurance contract 106, then broker server 108 may take action. In some embodiments, insurance broker server 108 may transmit information about the improved offers to user 102 for user 102 to decide whether or not to switch insurance contract 106 to one of the offers 110. In other embodiments, broker server 108 may automatically update the current insurance contract 106 to the desired offer 110.

For example, broker server 108 may determine that one of the offers 110 covers all of the items that are important to user 102 based upon user profile 104. Broker server 108 may further determine that usage characteristics of user 102 in user profile 104 match (or are within tolerable ranges defined by) the target usage characteristics associated with that offer 110. Broker server 108 may then determine that that offer 110 is also significantly less expensive than current insurance contract 106. Broker server 108 may then cancel current insurance contract 106 and transfer user 102 to the determined offer 110. In some of these embodiments, broker server 108 may wait until current insurance contract 106 expires before switching user 102. In other embodiments, broker server 108 may determine that it is cost-effective to cancel current insurance contract 106 prior to its expiration date.

In the exemplary embodiment, broker server 108 may analyze offers 110 and current insurance contract 106 based upon both coverage options and cost. Furthermore, in embodiments where user 102 has ranked and/or rated coverage as more important than price, broker server 108 may chose a higher priced offer 110, where the coverage is greater and more in line with the desires of user 102 based upon user profile 104.

### Exemplary Computer-Implemented Method For Managing Insurance

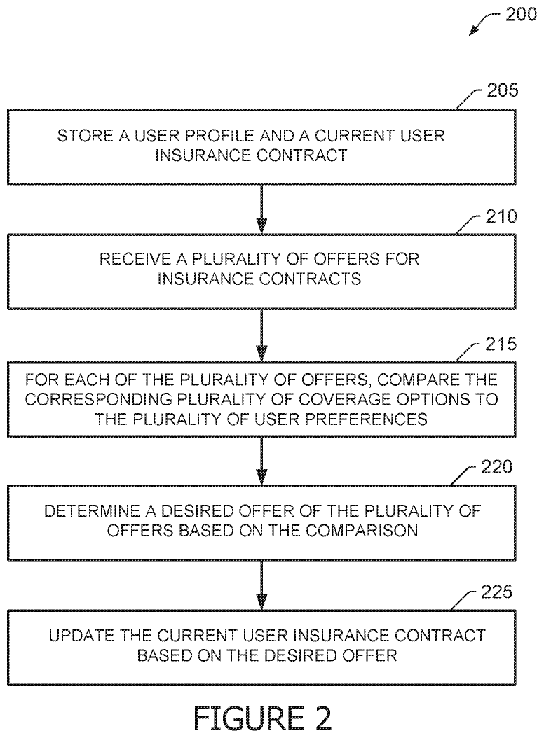

FIG. 2 illustrates a flow chart of an exemplary computer implemented process 200 for managing and updating user insurance contracts using process 100 shown in FIG. 1. Process 200 may be implemented by a computing device, for example insurance broker server 108 (shown in FIG. 1) or IM server 310 (shown in FIG. 3). In the exemplary embodiment, IM server 310 may be in communication with a plurality of insurance provider computer devices 305 (shown in FIG. 3) and at least one user computer device 325 (shown in FIG. 3).

In the exemplary embodiment, IM server 310 may store 205 a user profile 104 and a current user insurance contract 106 (both shown in FIG. 1). In the exemplary embodiment, user profile 104 may include a plurality of user preferences, and current user insurance contract 106 may include a plurality of coverage options. In the exemplary embodiment, IM server 310 may receive user profile 104 from user computer device 325.

In the exemplary embodiment, IM server 310 may receive 210 a plurality of offers 110 (shown in FIG. 1) from a plurality of insurance provider computer devices 305. Each of the offers 110 may include a plurality of coverage options, where each of the coverage options represents one or more details about an insurance contract associated with the offer 110. For each of the plurality of offers 110, IM server 310 may compare 215 the corresponding plurality of coverage options to the corresponding plurality of user preferences in user profile 104.

IM server 310 may determine 220 a desired offer 110 of the plurality of offers 110 based upon the comparison. In some embodiments, IM server 310 may transmit the desired offer 110 to user computer device 325 for the user's approval. Once IM server 310 receives the user's approval, IM server 310 may update 225 the current user insurance contract 106 based upon the desired offer 110. In some further embodiments, IM server 310 may determine 220 a plurality of desired offers 110. In these embodiments, IM server 310 may transmit the plurality of desired offers 110 to user computer device 325. User 102 (shown in FIG. 1) may select one of the plurality of desired offers 110 and transmit that selection to IM server 310. IM server 310 may update 225 current user insurance contract 106 based upon that selection.

In the exemplary embodiment, IM server 310 may update 225 the current user insurance contract 106 based upon the desired offer 110. IM server 310 may transmit approval of desired offer 110 to insurance provider computer device 305 including payment and other information from user profile 104 to put desired offer 110 in force as current user insurance contract 106.

In some embodiments, the plurality of user preferences in user profile 104 may include a plurality of ratings, where user 102 has rated the importance of different coverage options. In these embodiments, IM server 310 may compare the plurality of ratings to the plurality of coverage options for each of the plurality of offers 110. IM server 310 may determine a ranking for each of the plurality of offers 110 based upon the corresponding comparisons. For example, IM server 310 may determine that a first offer 110 ranks higher than a second offer 110 based upon how closely the first offer 110 aligns with the user preferences in comparison to how the second offer 110 aligns with the user preferences. In these embodiments, IM server 310 may determine 220 the desired offer 110 based upon the rankings. For example, IM server 310 may determine 220 that the highest ranked offer 110 is the desired offer 110.

In some further embodiments, IM server 310 may rank the current user insurance contract 106 with the ranked plurality of offers 110. If the current user insurance contract 106 ranks higher than any of the plurality of offers 110, IM server 310 may take no further action until there is a change in either the plurality of offers 110 or user profile 104. If one or more offers 110 rank higher than current user insurance contract 106, IM server 310 may transmit those offers 110 to user computer device 325 for user's review. In still other embodiments, IM server 310 may update 225 current user insurance contract 106 based upon the highest ranked offer, where the highest ranked offer 110 is ranked higher than current user insurance contract 106.

In some embodiments, IM server 310 may store the plurality of offers 110. In these embodiments, IM server 310 may receive additional offers 110 from one or more insurance provider computer devices 305. In these embodiments, IM server may update the stored plurality of offers 110 based upon the additional offers 110.

In some embodiments, user 102 may sign up for an insurance management service from IM server 310. In these embodiments, IM server 310 may request user 102 to provide a plurality of user preferences about insurance coverage options for a desired insurance contract. IM server 310 may transmit a plurality of questions and/or a survey to user computer device 325 for user 102 to fill out. IM server 310 may generate user profile 104 based upon the user's answers.

In some further embodiments, IM server 310 may determine a first current user insurance contract 106 based upon the plurality of offers 110 and user profile 104. In these embodiments, IM server 310 may determine one or more offers 110 of the plurality of offers 110 based upon user profile 104. IM server 310 may transmit one or more of these offers 110 to user computer device 325 for user 102 to choose. Once IM server 310 receives approval of one of the offers 110, IM server 310 may store the approved offer 110 as current user insurance contract 106. In these embodiments, IM server 310 may set up current user insurance contract 106.

In some embodiments, IM server 310 may be configured to perform the steps of process 200 on a periodic basis, such as once a month. In some cases, IM server 310 may not find an offer 110 that is better than current user insurance contract 106. In these situations, IM server 310 may notify user 102 that current user insurance contract 106 is currently the best available insurance contract 106.

A blockchain is a distributed database that maintains a continuously-growing list of ordered records, known as blocks. Each block may contain at least a timestamp and a link to the previous block in the chain. The link to the previous block may be a hash of the previous block. For an insurance contract, the first block may contain the initial contract between a driver and an insurer. The second block may contain a modification to the contract that was requested by the driver and approved by the insurer. The second block may contain a hashed copy of the first block as well. The third block may contain one or more additional terms for the insurance contract and a hashed copy of the second block. This continues on with each block adding on to the next while containing a hash of the previous blocks in the blockchain.

To ensure the security of the information contained in the blockchain, copies of the blockchain may be distributed across multiple computer devices, known as nodes. These nodes maintain the blockchain, update the blockchain when changes occur, and ensure the stability of the blockchain itself. In some embodiments, nodes may be also used to calculate the hash of the previous blocks. As the blockchain grows, the processing power needed to calculate the hash of the previous blocks grows as well. In these embodiments, the processing of the hash may be distributed over multiple computer devices to improve the speed of processing and/or to not overburden the hashing processor. When a node processes (hashes) a block, that node is known as a miner, where the action of validating and hashing the block is also known as mining.

In the exemplary embodiment, user insurance contract 106 is stored in a blockchain structure. In the exemplary embodiment, user insurance contract 106 may be stored in a plurality of locations including insurance broker server 108, IM server 310, user computer device 325, insurance provider computer devices 305, and database 320 (shown in FIG. 3). In the exemplary embodiment, user insurance contract 106 is a blockchain ledger that is distributed among a plurality of participants (also known as nodes). The nodes are capable of communicating with the system 300 (shown in FIG. 3) though an application programming interface (API). The system 300 may also use the API to communicate with outside applications, such as, but not limited to, data sources about the user/insured and other applications as necessary to work as described herein. In the exemplary embodiment, the system 300 may include a firewall to protect the private information of the driver. In some further embodiments, the private information is only stored by the system 300 and is not stored in the blockchain ledger. In some further embodiments, user profile 104 is also stored in a blockchain structure. In some embodiments, user profile 104 is stored in a separate blockchain from user insurance contract 106. In other embodiments, user profile 104 is stored in the same blockchain as user insurance contract 106.

In the exemplary embodiment, when user insurance contract 106 is updated 225, IM server 310 updates the blockchains storing user insurance contract 106. In some embodiments, this update may be performed at the prime node (such as at IM server 310) and a new block is transmitted to the other nodes in the blockchain ledger. In other embodiments, information about the update may be transmitted to the other nodes in the blockchain ledger for them to create their own blocks. In some embodiments, IM server 310 or insurance provider 112 store the offers 110 in blockchains as well. In some embodiments, this update may include a plurality of offers 110 that were compared 215 to user insurance contract 106. In other embodiments, the update may be a new block for the blockchain that includes a new insurance contract 106 from a different insurance provider 112 based on the desired offer.

In the exemplary embodiment, each user insurance contract 106 is stored in its own blockchain ledger. As the user insurance contract 106 is modified or additional information is added to the user insurance contract 106, such as telematics information, another block may be added to the blockchain of the user insurance contract 106. In some other embodiments, each offer 110 that is compared to user insurance contract 106 is also stored in the blockchain for that user insurance contract 106.

### Exemplary Computer Network

FIG. 3 depicts a simplified block diagram of an exemplary system 300 for implementing process 100 shown in FIG. 1 and/or process 200 shown in FIG. 2. In the exemplary embodiment, system 300 may be used for managing and updating insurance contracts. As described below in more detail, an insurance management (“IM”) server 310, which may be similar to broker server 108 (shown in FIG. 1), may be configured to (i) store a user profile 104 and a current user insurance contract 106 (both shown in FIG. 1), where user profile 104 includes a plurality of user preferences; (ii) receive a plurality of offers 110 (shown in FIG. 1) for insurance contracts, where each of the plurality of offers 110 includes a plurality of coverage options; (iii) for each of the plurality of offers 110, compare the corresponding plurality of coverage options to the plurality of user preferences; (iv) determine a desired offer of the plurality of offers 110 based upon the comparison; and/or (v) update the current user insurance contract 106 based upon the desired offer.

In the exemplary embodiment, insurance provider computer devices 305 may be computers that include a web browser or a software application, which enables insurance provider computer devices 305 to access remote computer devices, such as IM server 310, using the Internet or other network. More specifically, insurance provider computer devices 305 may be communicatively coupled to IM server 310 through many interfaces including, but not limited to, at least one of the Internet, a network, such as the Internet, a local area network (LAN), a wide area network (WAN), or an integrated services digital network (ISDN), a dial-up-connection, a digital subscriber line (DSL), a cellular phone connection, and a cable modem. Insurance provider computer devices 305 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In the exemplary embodiment, insurance provider computer device 305 is associated with insurance provider 112 (shown in FIG. 1).

In the exemplary embodiment, user computer devices 325 may be computers that include a web browser or a software application, which enables user computer devices 325 to access remote computer devices, such as IM server 310, using the Internet or other network. More specifically, user computer devices 325 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. User computer devices 325 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

A database server 315 may be communicatively coupled to a database 320 that stores data. In one embodiment, database 320 may include the plurality of offers 110, user profile 104, insurance contract 106, and/or one or more business rules. In the exemplary embodiment, database 320 may be stored remotely from IM server 310. In some embodiments, database 320 may be decentralized. In the exemplary embodiment, a user, such as user 102, may access database 320 via user computer device 325 by logging onto IM server 310, as described herein.

IM server 310 may be in communication with a plurality of insurance provider computer devices 305 and a plurality of user computer devices 325 to communicate a plurality of offers 110 for insurance contracts 106 to user 102. In some embodiments, IM server 310 may be associated with an insurance provider 112, or in communication with the insurance provider's computer network (not shown). In other embodiments, IM server 310 may be associated with a third party and is merely in communication with the insurance provider's computer network.

In some embodiments, IM server 310 may be further in communication with at least one telematics computer device 330. Telematics computer devices 330 may include any computer device configured to generate, collect, and/or store telematics data. Telematics computer devices 330 may include user computer devices 325, in some embodiments. In other embodiments, telematics computer devices 330 may include other computer devices, for instance, those computer devices associated with the subject of an insurance contract 106 offered by insurance providers 112. For example, telematics computer devices 330 may include vehicle devices (e.g., a computer device integral to and/or removably coupled to a vehicle), smart home computing devices (e.g., smart home “hubs”), Internet of Things devices, and/or similar computer devices. IM server 310 may access telematics computer device 330 to retrieve telematics data associated with a user, such that IM server 310 may update or generate a user profile (e.g., user profile 104) to include a usage profile based upon the telematics data, as described further herein. Additionally or alternatively, telematics computer device 330 may store telematics data in database 320, such that IM server 310 may access the telematics data from database 320.

In some embodiments, IM server 310 may be further in communication with at least one game computer device 335. Game computer devices 335 may include any computer device configured to provide gameplay to a user. In some embodiments, game computer devices 335 may be in communication with user computer devices 325. In other embodiments, game computer devices 335 may be user computer devices 325. In the exemplary embodiment, game computer device 335 may be in direct communication with telematics computer device 330. In other embodiments, game computer device 335 may be in communication with telematics computer device 330 through user computer device 325. For example, game computer device 335 may be a computer device that provides a telematics-based computer game to user, where user is able to play the computer game on user computer device 325. In the exemplary embodiment, telematics data from one or more vehicle devices may affect the gameplay of computer game provided by game computer device 335. IM server 310 may access game computer device 335 to retrieve telematics data or game profile data associated with a user, such that IM server 310 may update or generate a usage profile to include with a user profile based upon at least one of the telematics data and the game profile, as described further herein. Additionally or alternatively, game computer device 335 may store telematics data in database 320, such that IM server 310 may access the game profile from database 320.

### Exemplary Client Device

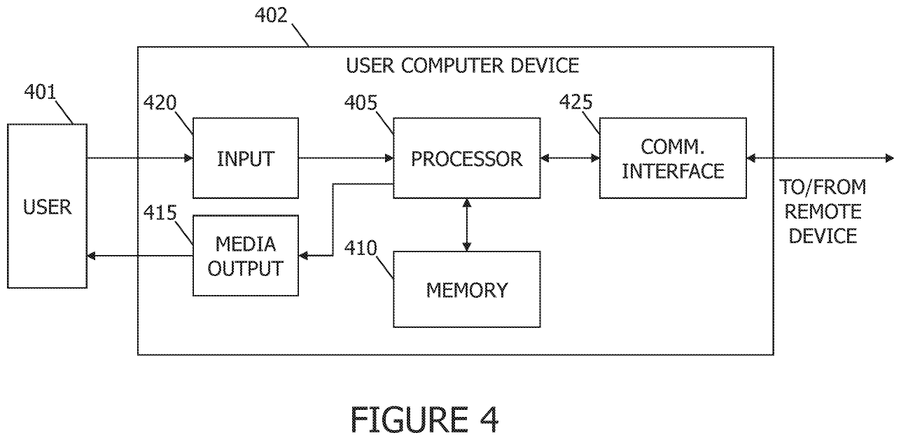

FIG. 4 depicts an exemplary configuration of client computer device, in accordance with one embodiment of the present disclosure. User computer device 402 may be operated by a user 401. User computer device 402 may include, but is not limited to, insurance provider computer device 305, user computer devices 325, telematics computer device 330, and game computer device 335 (all shown in FIG. 3). User computer device 402 may include a processor 405 for executing instructions. In some embodiments, executable instructions may be stored in a memory area 410. Processor 405 may include one or more processing units (e.g., in a multi-core configuration). Memory area 410 may be any device allowing information such as executable instructions and/or transaction data to be stored and retrieved. Memory area 410 may include one or more computer readable media.

User computer device 402 may also include at least one media output component 415 for presenting information to user 401. Media output component 415 may be any component capable of conveying information to user 401. In some embodiments, media output component 415 may include an output adapter (not shown) such as a video adapter and/or an audio adapter. An output adapter may be operatively coupled to processor 405 and operatively coupleable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 415 may be configured to present a graphical user interface (e.g., a web browser and/or a client application) to user 401. A graphical user interface may include, for example, an online store interface for viewing and/or selecting from the plurality of offers 110 (shown in FIG. 1). In some embodiments, user computer device 402 may include an input device 420 for receiving input from user 401. User 401 may use input device 420 to, without limitation, select an offer 110.

Input device 420 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 415 and input device 420.

User computer device 402 may also include a communication interface 425, communicatively coupled to a remote device such as IM server 310 (shown in FIG. 3). Communication interface 425 may include, for example, a wired or wireless network adapter and/or a wireless data transceiver for use with a mobile telecommunications network.

Stored in memory area 410 are, for example, computer readable instructions for providing a user interface to user 401 via media output component 415 and, optionally, receiving and processing input from input device 420. A user interface may include, among other possibilities, a web browser and/or a client application. Web browsers enable users, such as user 401, to display and interact with media and other information typically embedded on a web page or a website from IM server 310. A client application may allow user 401 to interact with, for example, IM server 310. For example, instructions may be stored by a cloud service, and the output of the execution of the instructions sent to the media output component 415.

### Exemplary Server Device

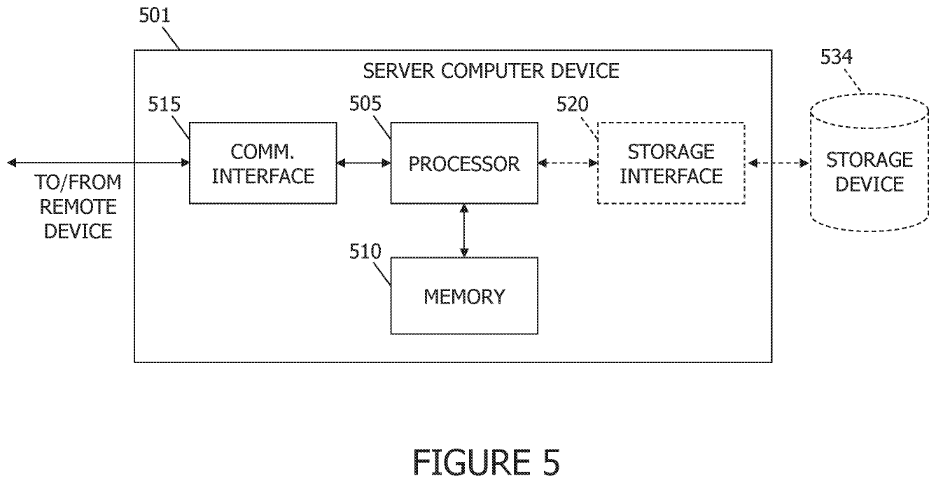

FIG. 5 depicts an exemplary configuration of a server system, in accordance with one embodiment of the present disclosure. Server computer device 501 may include, but is not limited to, broker server 108 (shown in FIG. 1), insurance provider computer device 305, IM server 310, database server 315, and game computer device 335 (all shown in FIG. 3). Server computer device 501 may also include a processor 505 for executing instructions. Instructions may be stored in a memory area 510. Processor 505 may include one or more processing units (e.g., in a multi-core configuration).

Processor 505 may be operatively coupled to a communication interface 515 such that server computer device 501 is capable of communicating with a remote device such as another server computer device 501, IM server 310, insurance provider computer device 305, user computer device 325, telematics computer device 330, and game computer device 335 (all shown in FIG. 3) (for example, using wireless communication or data transmission over one or more radio links or digital communication channels). For example, communication interface 515 may receive requests from user computer devices 325 via the Internet, as illustrated in FIG. 3.

Processor 505 may also be operatively coupled to a storage device 534. Storage device 534 may be any computer-operated hardware suitable for storing and/or retrieving data, such as, but not limited to, data associated with database 320 (shown in FIG. 3). In some embodiments, storage device 534 may be integrated in server computer device 501. For example, server computer device 501 may include one or more hard disk drives as storage device 534.

In other embodiments, storage device 534 may be external to server computer device 501 and may be accessed by a plurality of server computer devices 501. For example, storage device 534 may include a storage area network (SAN), a network attached storage (NAS) system, and/or multiple storage units such as hard disks and/or solid state disks in a redundant array of inexpensive disks (RAID) configuration.

In some embodiments, processor 505 may be operatively coupled to storage device 534 via a storage interface 520. Storage interface 520 may be any component capable of providing processor 505 with access to storage device 534. Storage interface 520 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 505 with access to storage device 534.

Processor 505 may execute computer-executable instructions for implementing aspects of the disclosure. In some embodiments, the processor 505 may be transformed into a special purpose microprocessor by executing computer-executable instructions or by otherwise being programmed. For example, the processor 505 may be programmed with the instruction such as illustrated in FIG. 2.

### Exemplary Computer Device

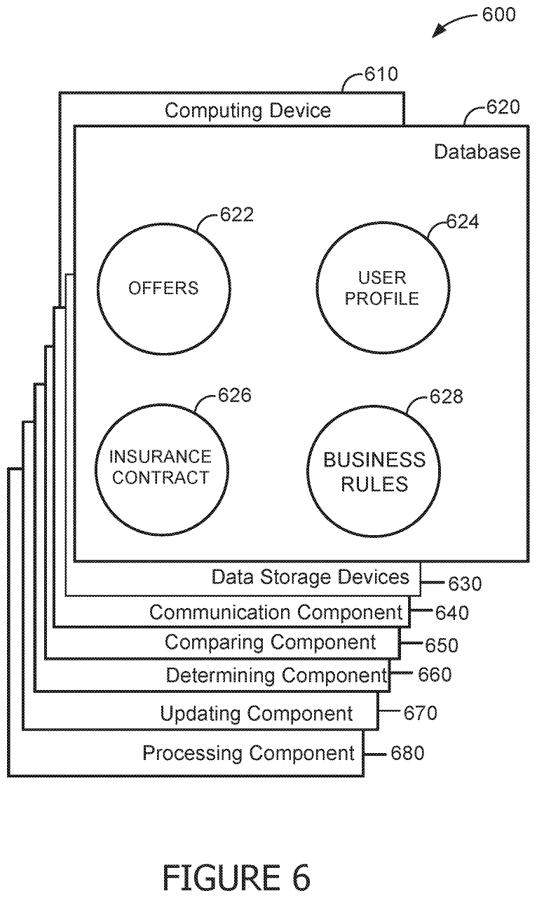

FIG. 6 depicts a diagram 600 of components of one or more exemplary computing devices 610 that may be used to implement process 100 (shown in FIG. 1) and system 300 (shown in FIG. 3). In some embodiments, computing device 610 may be similar to broker server 108 (shown in FIG. 1) and/or IM server 310 (shown in FIG. 3). Database 620 may be coupled with several separate components within computing device 610, which perform specific tasks. In this embodiment, database 620 may include the plurality of offers 622 (which may be similar to offer 110, shown in FIG. 1), user profile 624 (which may be similar to user profile 104, shown in FIG. 1), insurance contract 626 (which may be similar to insurance contract 106, shown in FIG. 1), and one or more business rules 628. In some embodiments, database 620 is similar to database 320 (shown in FIG. 3).

Computing device 610 may include the database 620, as well as data storage devices 630. Computing device 610 may also include a communication component 640 for receiving 210 a plurality of offers 110 (shown in FIG. 2). Computing device 610 may further include a comparing component 650 for comparing 215 the corresponding plurality of coverage options (shown in FIG. 2). Moreover, computing device 610 may include a determining component 660 for determining 220 a desired offer (shown in FIG. 2). In addition, computing device 610 may include an updating component 670 for updating 225 the current user insurance contract (shown in FIG. 2). A processing component 680 may assist with execution of computer-executable instructions associated with the system.

### Exemplary Telematics Computer Device

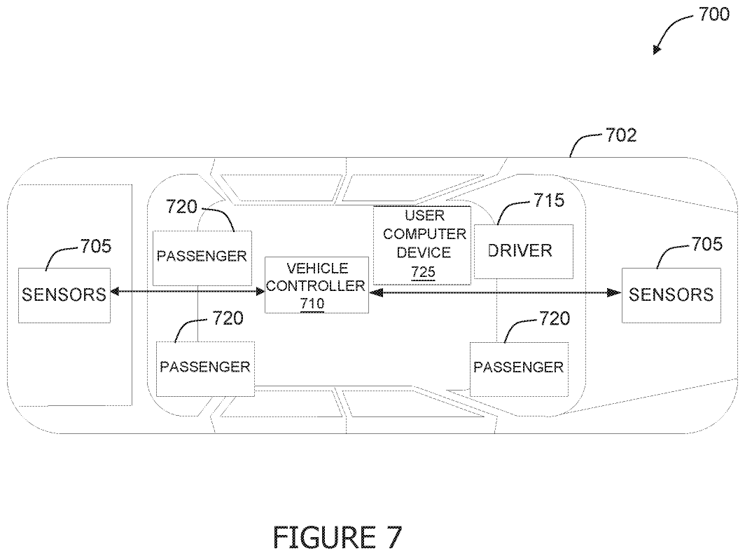

FIG. 7 depicts a view of an exemplary telematics computer device 700 embodied as a vehicle 702 including a vehicle controller 710. In the exemplary embodiment, vehicle 702 may be an autonomous or semi-autonomous vehicle capable of fulfilling the transportation capabilities of a traditional automobile or other vehicle. In these embodiments, vehicle 702 may be capable of sensing its environment and navigating without human input. In other embodiments, vehicle 702 is a manual vehicle, such as a traditional automobile that is controlled by a driver 715.

Vehicle 702 may include a plurality of sensors 705 and a vehicle controller 710, which may include and/or be similar to telematics computer device 330 (shown in FIG. 3). The plurality of sensors 705 may detect the current surroundings and location of vehicle 702. Plurality of sensors 705 may include, but are not limited to, radar, LIDAR, Global Positioning System (GPS), video devices, imaging devices, cameras, audio recorders, and computer vision. Plurality of sensors 705 may also include sensors that detect conditions of vehicle 702, such as speed, acceleration, gear, braking, and other conditions related to the operation of vehicle 702, for example: at least one of a measurement of at least one of speed, direction, rate of acceleration, rate of deceleration, location, position, orientation, and rotation of the vehicle, and a measurement of one or more changes to at least one of speed, direction, rate of acceleration, rate of deceleration, location, position, orientation, and rotation of the vehicle. Furthermore, plurality of sensors 705 may include impact sensors that detect impacts to vehicle 702, including force and direction, and sensors that detect actions of vehicle 702, such the deployment of airbags. In some embodiments, plurality of sensors 705 may detect the presence of driver 715 and one or more passengers 720 in vehicle 702. In these embodiments, plurality of sensors 705 may detect the presence of fastened seatbelts, the weight in each seat in vehicle 702, heat signatures, or any other method of detecting information about driver 715 and passengers 720 in vehicle 702.

In certain embodiments, plurality of sensors 705 may include occupant position sensors to determine a location and/or position of each occupant (i.e., driver 715 and, in some embodiments, passengers 720) in vehicle 702. The location of an occupant may identify a particular seat or other location within vehicle 702 where the occupant is located. The position of the occupant may include the occupant's body orientation, the location of specific limbs, and/or other positional information. In one example, plurality of sensors 705 may include an in-cabin facing camera, LIDAR, radar, weight sensors, accelerometer, gyroscope, compass and/or other types of sensors to identify the location and/or position of occupants within vehicle 702.

Vehicle controller 710 may interpret the sensory information to identify appropriate navigation paths, detect threats, and react to conditions. In some embodiments, vehicle controller 710 may be able to communicate with one or more remote computer devices, such as a user computer device 725 (which may include and/or be similar to user computer device 325, shown in FIG. 3). In the example embodiment, user computer device 725 is associated with driver 715 and includes one or more internal sensors, such as an accelerometer, a gyroscope, and/or a compass. User computer device 725 may be capable of communicating with vehicle controller 710 wirelessly. In addition, vehicle controller 710 and/or user computer device 725 may be configured to communicate with computer devices located remotely from vehicle 702, such as IM server 310 (shown in FIG. 3).

In some embodiments, vehicle 702 may include autonomous or semi-autonomous vehicle-related functionality or technology that may be used with the present embodiments to replace human driver actions may include and/or be related to the following types of functionality: (a) fully autonomous (driverless); (b) limited driver control; (c) vehicle-to-vehicle (V2V) wireless communication; (d) vehicle-to-infrastructure (and/or vice versa) wireless communication; (e) automatic or semi-automatic steering; (f) automatic or semi-automatic acceleration; (g) automatic or semi-automatic braking; (h) automatic or semi-automatic blind spot monitoring; (i) automatic or semi-automatic collision warning; (j) adaptive cruise control; (k) automatic or semi-automatic parking/parking assistance; (l) automatic or semi-automatic collision preparation (windows roll up, seat adjusts upright, brakes pre-charge, etc.); (m) driver acuity/alertness monitoring; (n) pedestrian detection; (o) autonomous or semi-autonomous backup systems; (p) road mapping systems; (q) software security and anti-hacking measures; (r) theft prevention/automatic return; (s) automatic or semi-automatic driving without occupants; and/or other functionality. In these embodiments, the autonomous or semi-autonomous vehicle-related functionality or technology may be controlled, operated, and/or in communication with vehicle controller 710.

The wireless communication-based autonomous or semi-autonomous vehicle technology or functionality may include and/or be related to: automatic or semi-automatic steering; automatic or semi-automatic acceleration and/or braking; automatic or semi-automatic blind spot monitoring; automatic or semi-automatic collision warning; adaptive cruise control; and/or automatic or semi-automatic parking assistance. Additionally or alternatively, the autonomous or semi-autonomous technology or functionality may include and/or be related to: driver alertness or responsive monitoring; pedestrian detection; artificial intelligence and/or back-up systems; navigation or GPS-related systems; security and/or anti-hacking measures; and/or theft prevention systems.

Moreover, where vehicle 702 is an autonomous or semi-autonomous vehicle, vehicle controller 710 may interpret sensory information from sensors 705 to determine usage of vehicle 702 by one or more users (e.g., driver 715 and/or passengers 720) for each trip undertaken by vehicle 702. As used herein, “trip” refers to a discrete use of vehicle 702, from an initial starting point (e.g., starting vehicle 702) to an end point (e.g., reaching a destination or turning off vehicle 702). Determining usage of vehicle 702 by one or more users may facilitate collecting and/or generating vehicle-based telematics data associated with each user.

In addition, vehicle controller 710 may interpret the sensory information to identify vehicle users (e.g., driver 715 and/or passengers 720) present in vehicle 702 during a trip. For example, vehicle controller 710 may determine positional information for at least one vehicle user of vehicle 702 present in vehicle 702 during a trip. Positional information may include a position of a vehicle user, a direction of facing of the vehicle user, a size of the vehicle user, and/or a skeletal positioning of the vehicle user. The position of the vehicle user may include which seat the vehicle user occupies. The direction of facing of the vehicle user may include whether the vehicle user is facing forward, reaching forward, reaching to the side, and/or has his/her head turned. The size of the vehicle user may determine whether the vehicle user is an adult or a child. The size of the vehicle user may also include the vehicle user's height. The skeletal positioning may include positioning of the vehicle user's joints, spine, arms, legs, torso, neck face, head, major bones, hands, and/or feet.

Where vehicle 702 is a semi-autonomous or regular vehicle, such that a driver 715 controls vehicle 702 during part or the entirety of one or more trips, vehicle controller 710 may interpret sensory information to collect and/or generate telematics data associated with driving characteristics of driver 715. For example, vehicle controller 710 may collect vehicle telematics data from user computer device 725 and/or one or more of sensors 705. Vehicle telematics data may include data from user computer device 725 and/or one or more of sensors 705 and may include navigation, communications, safety, security, and/or “infotainment” data. For example, vehicle telematics data collected and analyzed by vehicle controller 710 may include, but is not limited to braking and/or acceleration data, navigation data, vehicle settings (e.g., seat position, mirror position, temperature or air control settings, etc.), remote-unlock and/or remote-start data (e.g., determining which user computer device 725 is used to unlock or start vehicle 702) and/or any other telematics data.

In some embodiments, vehicle 702, vehicle controller 710, and/or user computer device 725 may be configured to track driving characteristics of vehicle 702 and/or driver 715 during a trip. Additionally or alternatively, a separate telematics computer device 330 may be provided for use with vehicle 702 (e.g., may be “plugged in” or otherwise coupled to vehicle 702) that tracks driving characteristics. “Driving characteristics” may include, for example (but not limited to), sudden acceleration/deceleration, average speed, average stopping distance, and driving efficiency, as well as times of the day/week vehicle 702 is driven, distance driven, and/or location information of the trip. Vehicle controller 710, user computer device 725, and/or IM server 310 may employ machine learning functionality to develop and maintain “driver usage profiles” or “driving profiles” for each driver 715 of vehicle 702 that characterizes the driving of driver 715, such that IM server 310 may update or generate a user profile 104 (shown in FIG. 1) for that driver 715 to include the driving profile. For example, a driver 715 may exhibit one or more high-risk behaviors, according to collected vehicle telematics data (e.g., high occurrence of abrupt deceleration, particularly fast turns, and/or extreme acceleration).

The driving profile may include one or more usage characteristics that represent various risk behaviors exhibited (or not exhibited) by driver 715. For instance, one usage characteristic may include a numeric value or other indicator that represents driver 715 rarely drives above a posted speed limit. As another example, another usage characteristic may include a numeric value or other indicator that represents driver 715 frequently drives at “high-risk” times of the day, such as between midnight and 6AM. As another example, a usage characteristic may be associated with maintenance of the vehicle, such as how often maintenance is performed, or whether or not scheduled maintenance is performed in a timely manner.

In some embodiments, multiple users may have access to vehicle 702, such that one or more users may act as driver 715 for different trips undertaken using vehicle 702. Accordingly, vehicle controller 710 may be configured to determine which of these users is acting as driver 715 for each trip, such that telematics data associated with any particular trip may be correctly attributed to a driving profile for the correct driver 715.

In one embodiment, vehicle 702 may include a communication device that allows it to communicate with other devices, for example, via the Internet or any other wired or wireless connection (e.g., Bluetooth®) over one or more radio links or wireless communication channels. Vehicle 702 may be in communication with one or more user computer devices 725 that are each associated with one of users of vehicle 702. In some embodiments, vehicle 702 may have “application pairing” functionality via the communication device, such that vehicle users may engage with an app on a user interface at the vehicle and/or on their user computer device 725 (e.g., their smartphone). In one embodiment, at the beginning and/or at the end of a trip, the app may prompt selection of which vehicle user is/was the driver 715 of the trip, and vehicle controller 710 may record the selected driver 715 as the driver 715 for the trip, such that telematics data associated with that trip may be attributed to the correct driver 715.

Additionally or alternatively, this method may be employed as a validation or verification to one or more other determination methods. For example, after a trip in which the driver 715 is determined using another method, the app may prompt confirmation that the determined driver 715 was, in fact, the driver 715 of the trip. Vehicle controller 710 may receive an indication of a positive or negative response to the prompt, and update records for the trip accordingly.

Using the application pairing functionality, vehicle controller 710 may further determine which user computer device(s) 725 are within vehicle 702 during a trip. For example, each user may pair one or more user computer devices 725 (e.g., smartphones, tablets, laptops, wearables, etc.) to vehicle 702. Vehicle 702 may then pair with one or more user computer devices 725 that are within vehicle 702 during a trip. Vehicle controller 710 may record which device(s) 725 pair with vehicle 702 for a trip. If only one user computer device 725 pairs with vehicle 702, vehicle controller 710 may determine that the user associated with that user computer device 725 was the driver 715 for the trip. If more than one user computer device 725 pairs with vehicle 702, vehicle controller 710 may request selection and/or confirmation of which associated vehicle user is the driver 715 for the trip, as described above (e.g., using an in-vehicle app and/or an app on the user computer device 725).

In still other embodiments, vehicle controller 710 may use additional and/or alternative vehicle telematics data, such as sensor information from sensors within a paired user computer device 725, to determine which vehicle user is the driver 715 when multiple user computer devices 725 pair with vehicle 702 during a single trip. In one example, vehicle controller 710 may use gyroscope and/or accelerometer sensor information from the paired user computer devices 725 to identify which side of vehicle 702 each user of a user computer device 725 used to enter vehicle 702 and/or exit vehicle 702. In other words, vehicle controller 710 may access and process data from the gyroscope and/or accelerometer for each user computer device 725 to determine whether the user of the user computer device 725 entered vehicle 702 on the left (e.g., driver) or the right (e.g., passenger).

If only two user computer devices 725 are present and vehicle controller 710 determines that a first device 725 is associated with the left side of vehicle 702 and a second device 725 is associated with the right side of vehicle 702, vehicle controller 710 may record that the user associated with the first device 725 is the driver 715 and the user of the second device 725 is a passenger 720 for the trip. If more than one device 725 is associated with the left side of vehicle 702 (e.g., the driver's side), vehicle controller 710 may employ one or more other methods described herein to determine the driver 715 of vehicle 702. It should be understood that although the left side is associated with a “driver's side” and the right side is associated with a “passenger side” herein, as is the custom in the United States of America, this method is easily applied to other driving customs in which the left side is a passenger side and the right side is the driver's side.

Another method of determining the driver 715 of a trip may include providing user-specific keys. For instance, each user of vehicle 702 may receive a user-specific key fob (or other device, such as a mobile device, i.e., smartphone or wearable electronics), which is registered to that specific user. The users may sign a contract or other agreement that each user will only use the key specific to his- or herself, which may encourage the vehicle users to carefully and consistently only use their specific key. When the user-specific key is employed to unlock and/or start vehicle 702 (e.g., in keyless start vehicles), vehicle controller 710 may record which key is used, and, therefore, may identify which vehicle user to designate as the driver 715 for the trip. Additionally or alternatively, location-sensitive tracking may be used to determine which user-specific key is within vehicle 702 during the trip. If only one user-specific key is sensed, vehicle controller 710 may record which user-specific key was sensed, may automatically designate the associated vehicle user as the driver 715.

Moreover, vehicle controller 710 may use driving profiles developed as described herein to identify drivers 715 of one or more trips in vehicle 702. For example, driving 15 miles in the morning at average speeds of 50 mph and with few sudden decelerations may be associated with User A (e.g., a commuting user) for a dozen trips using one or more of the above methods, such that any other trips that share some or all of these characteristics may be automatically associated with User A (e.g., without using any or all of the above methods).

In still other embodiments, vehicle 702 may include and employ one or more biometric sensors 705 to determine which vehicle user is the driver 715 for a trip. Biometric sensors 705 may include any sensor 705 configured to receive a biological signal uniquely identifying an individual, such as, but not limited to, retinal scanners, fingerprint scanners, facial recognition devices, and weight scales. In one example, vehicle 702 may have one or more fingerprint scanners on a component of vehicle 702 only easily accessible by the driver, such as the dashboard, the console, or the steering wheel. In another example, vehicle 702 may have a weight scale (or pressure sensor) associated with the driver's seat and/or with the passenger's seats. Vehicle 702 may have a registered weight associated with each user of vehicle 702. When any vehicle user sits in any of the seats, their weight may be measured by the scale and the particular vehicle user may be identified.

IM server 310 may access or retrieve telematics data collected by vehicle 702, vehicle controller 710, sensors 705, and/or user computer device 725 to generate the driving profile for driver 715 including the one or more usage characteristics. IM server 310 may periodically access or retrieve new or updated telematics data from subsequent trips or subsequent periods of time. IM server 310 may update the driving profile and/or usage characteristics based upon the new or updated telematics data. For example, if driver 715 no longer drives at “high-risk” times of the day, IM server 310 may update that usage characteristic. When the telematics data shows that driver 715 has reduced one or more risky behaviors, IM server 310 may update the driving profile accordingly. IM server 310 may update the user profile 104 associated with driver 715, which may provide driver 715 with opportunities for “better” (e.g., cheaper or more comprehensive) offers 110 (shown in FIG. 1). In other words, a change in the driving profile (whether to less risk or more risk) may change the comparison of that driving profile to the offers 110 performed by IM server 310.

While vehicle 702 may be an automobile in the exemplary embodiment, in other embodiments, vehicle 702 may be, but is not limited to, any vehicle owned, operated, and/or used by one or more users. A vehicle may include any kind of vehicle, such as, for example, cars, trucks, all-terrain vehicles (ATVs), motorcycles, recreational vehicles (RVs), snowmobiles, boats, autonomous vehicles, semi-autonomous vehicles, industrial vehicles (e.g., construction vehicles), “riding” lawnmowers, planes, and/or any kind of land-, water-, or air-based vehicle.

Moreover, it should be understood that a telematics computer device may be implemented in other forms and/or in other (non-vehicle) devices. For example, a telematics computer device 330 may include a computer device associated with any property under an insurance contract. “Property,” as used herein, may refer generally to any residential or commercial building (and/or other property type) and/or to particular spaces therein. For example, a property may include (but is not limited to) a home, an apartment, a condominium, one or more offices, one or more floors of a building, “common areas” (e.g., lobbies, stairwells, conference rooms, etc.), etc. Moreover, in some embodiments, a shared property may refer additionally or alternatively to vehicles (including automobiles, cars, trucks, boats, RVs, snowmobiles, ATVs, etc.), storage space, lawn equipment, trailers, campers, tools (e.g., table saws, lathes, etc.), and/or personal property (e.g., computers, accessories, etc.). In such examples, the telematics computer device 330 may include any computer device capable of and/or configured to collect, generate, store, process, and/or transmit telematics data associated with that property.

In one example, the property may include a home or other residential property. In such cases, the telematics computer device may include a smart home hub telematics computer device configured to communicate with a plurality of sensors and/or Internet of Things devices distributed throughout the property. The telematics data may be associated with usage of the home, such as utility usage, as well as certain usage or risk behaviors, such as closing/opening a garage door, locking/unlocking a door, etc. In these cases, usage characteristics of a usage profile associated with the user and the property may describe how conscientious a user is of keeping their property secured, keeping utility usage low, performing scheduled maintenance of appliances, and/or any other characteristic(s) associated with usage of the property.

In addition, in certain embodiments, more than one property may be associated with a particular offer 110 (or insurance contract 106, shown in FIG. 1, associated therewith). For example, a user 102 (shown in FIG. 1) may have more than one vehicle 702 covered by one or more offers 110 and/or insurance contracts 106. In such embodiments, a telematics computer device 330 may be removable and/or portable such that the user 102 may transfer telematics computer device 330 between vehicle 702 to continually collect telematics data for all trips associated with that user 102, no matter which vehicle 702 is being used. It should be readily understood that telematics computer device 330 may include a user computer device 325 in some such cases, which may simplify the transfer of telematics computer device 330, as user 102 is likely to have user computer device 325 on their person at most times.

### Exemplary Computer-implemented Method for Insurance Contracts Using Telematics Data to Build a User Profile

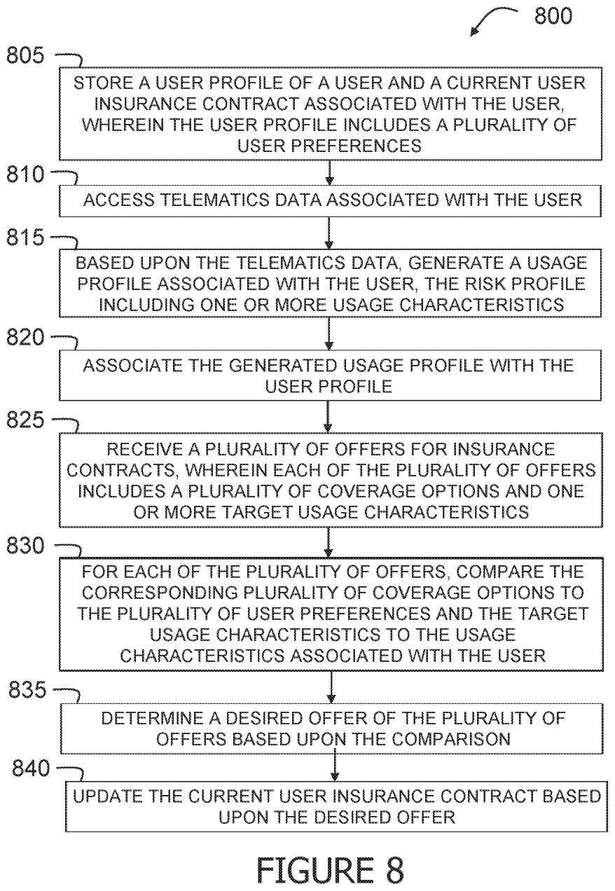

FIG. 8 illustrates a flow chart of an exemplary computer-implemented process 800 for managing and updating user insurance contracts using telematics data to build or update a user profile. Process 800 may be implemented by a computer device, for example insurance broker server 108 (shown in FIG. 1) or IM server 310 (shown in FIG. 3). In the exemplary embodiment, IM server 310 may be in communication with a plurality of insurance provider computer devices 305, at least one user computer device 325, and at least one telematics computer device 330 (all shown in FIG. 3), such as a vehicle computer device (e.g., vehicle controller 710, shown in FIG. 7).

In the exemplary embodiment, IM server 310 may store 805 a user profile 104 and a current user insurance contract 106 (both shown in FIG. 1). In the exemplary embodiment, user profile 104 may include a plurality of user preferences, and current user insurance contract 106 may include a plurality of coverage options. In the exemplary embodiment, IM server 310 may receive user profile 104 from user computer device 325.

IM server 310 may access 810 telematics data associated with the user. In the exemplary embodiment, the telematics data includes at least one of speed data, acceleration data, braking data, location data, route data, navigation data, distance data, timing data, and duration data. IM server 310 may access 810 the telematics data from a user computer device associated with the user (e.g., user computer device 325), and/or any other telematics computer device (e.g., telematics computer device 330). In some embodiments, IM server 310 may determine a device identifier of user computer device 325 associated with the user, and embed the device identifier into user profile 104. The device identifier may include any unique identifier, such as a phone number or a randomly generated alphanumeric identifier. In this way, IM server 310 may associate one or more user computer devices 325 with user profile 104, such that telematics data from user computer device 325 may be more easily identified as associated with the user. IM server 310 may then access 810 the telematics data generated by the user computer device 325. In some embodiments, IM server 310 may communicatively couple to user computer device 325 (e.g., as shown in FIG. 3) and may retrieve the telematics data from the user computer device 325. In other embodiments (as also shown in FIG. 3), user computer device 325 may store telematics data at a database (e.g., database 320, shown in FIG. 3), and IM server 310 may retrieve the telematics data therefrom.

In other embodiments, IM server 310 may determine a device identifier of a vehicle computer device (e.g., vehicle controller 710) of a vehicle (e.g., vehicle 702, shown in FIG. 7) associated with the user. The device identifier may include any unique identifier, such as a vehicle identification number (VIN), a phone number associated with telephonic capabilities or structure of the vehicle, or a randomly generated alphanumeric identifier. IM server 310 may embed the device identifier into user profile 104. IM server 310 may then access 810 the telematics data generated by the vehicle computer device. In some embodiments, IM server 310 may communicatively couple to the vehicle computer device and may retrieve the telematics data from the vehicle computer device. In other embodiments the vehicle computer device may store telematics data at a database (e.g., database 320), and IM server 310 may retrieve the telematics data therefrom.

Based upon the telematics data, IM server 310 may generate 815 a usage profile associated with the user. The usage profile may represent usage by the user 102 of a property intended to be covered by an insurance contract represented by an offer 110 (both shown in FIG. 1). The usage profile may include one or more usage characteristics. Usage characteristics may define or represent particular behaviors or variables exhibited (or not exhibited) by the user as they relate to the user's use of the property. In some embodiments, usage characteristics define risk/risky behaviors exhibited (or not exhibited) by the user. For instance, IM server 310 may analyze the telematics data according to a plurality of risk identification rules (e.g., rules 628, shown in FIG. 6) to identify particular behaviors evidenced by the telematics data, to thereby determine the one or more usage characteristics (e.g., a value that represents a level of risk associated with a behavior, such as driving speed, driving distance, driving time, etc.).

IM server 310 may associate 820 the generated usage profile with the user profile 104. In other words, IM server 310 may update the user profile 104 with the usage profile, which may provide a more complete or at least a more detailed depiction of user 102 to insurance providers 112 (shown in FIG. 1).

IM server 310 may receive 825 a plurality of offers 110 for insurance contracts. Each of the plurality of offers 110 includes a plurality of coverage options and one or more target usage characteristics. For each of the plurality of offers 110, IM server 310 may compare 830 the corresponding plurality of coverage options to the plurality of user preferences and the one or more target usage characteristics to the one or more usage characteristics associated with the user.

IM server 310 may determine 835 a desired offer 110 of the plurality of offers 110 based upon the comparison, and update 840 the current user insurance contract 106 based upon the desired offer.

In some embodiments, where the telematics data initially accessed includes “first” telematics data, IM server 310 may access second (e.g., new or updated) telematics data, the second telematics data generated after the first telematics data. IM server 310 may also update one or more risk characteristics of the usage profile, based upon the second telematics data.

In some embodiments, user profile 104 may be stored in a blockchain structure. In these embodiments, changes to user profile 104 are updated as additional or new blocks in the blockchain. In some other embodiments, the usage profile including telematics data may be stored in a blockchain structure. In some of these embodiments, IM server 310 may process the telematics data to store updates to the usage profile in the blockchain. In other embodiments, IM server 310 or user computer device 325 may store telematics data directly in the usage profile blockchain. In some of these embodiments, user computer device 325 may store additional telematics data in the user profile or usage profile blockchain periodically. In some other embodiments, user computer device 325 may store additional telematics data in the user profile or usage profile blockchain every time that user takes a trip.

### Exemplary Method for Matching Users to Insurance Providers

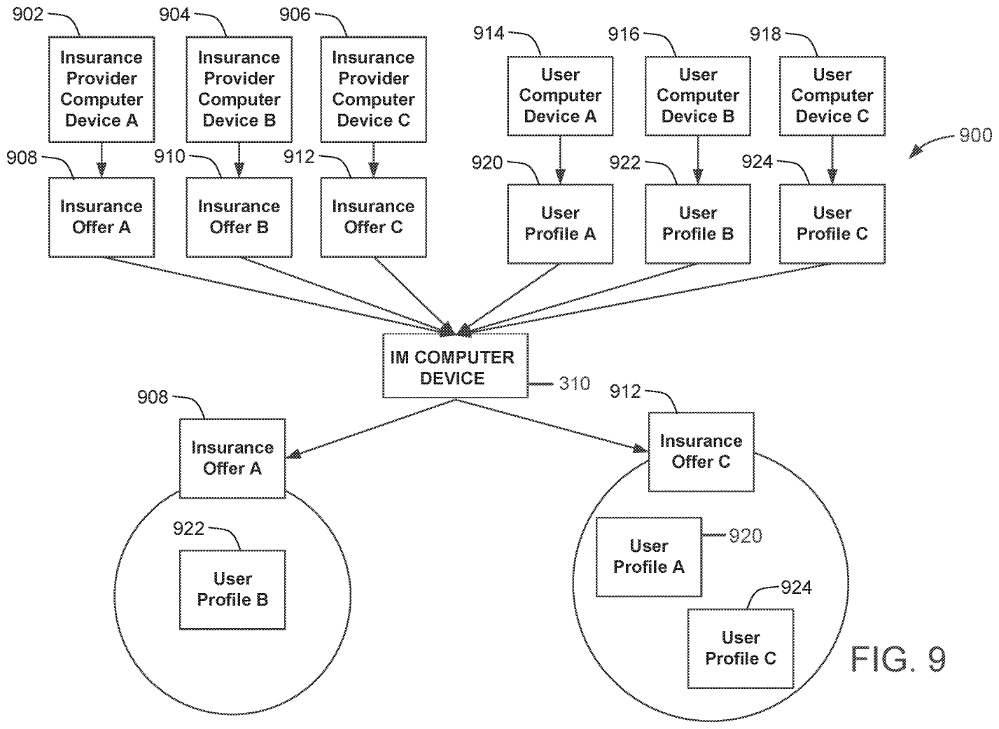

FIG. 9 illustrates a schematic diagram of another process 900 for matching users to insurance providers based upon user profiles and insurer bids using system 300 (shown in FIG. 3).

In the exemplary embodiment, a plurality of insurance provider computer devices A, B, & C 902, 904, & 906 generate a plurality of insurance offers A, B, & C 908, 910, and 912. In the exemplary embodiment, insurance provider computer devices A, B, & C 902, 904, & 906 may be similar to insurance provider computer device 305 (shown in FIG. 3) and are each associated with an insurance provider 112 (shown in FIG. 1). In the exemplary embodiment, the plurality of insurance offers 908, 910, and 912 are similar to offer 110 (shown in FIG. 1). In the exemplary embodiment, each of the insurance offers 908, 910, and 912 may include a plurality of coverage options, one or more target usage characteristics, and one or more prices associated with the one or more target usage characteristics. The insurance provider computer devices 902, 904, & 906 may transmit the corresponding insurance offers 908, 910, and 912 to IM server 310 (shown in FIG. 3). In some embodiments, the insurance provider computer devices 902, 904, & 906 may transmit the insurance offers 908, 910, and 912 on a periodic basis. In other embodiments, the insurance provider computer devices 902, 904, & 906 may transmit the insurance offers 908, 910, and 912 once, and may then transmit updates when necessary.

In the exemplary embodiment, a plurality of user computer devices A, B, & C 914, 916, & 918 generate a plurality of user profiles A, B, & C 920, 922, & 924. In the exemplary embodiment, user computer devices 914, 916, & 918 may be similar to user computer device 325 (shown in FIG. 3) and each is associated with a user 102 (shown in FIG. 1). In the exemplary embodiment, user profiles 920, 922, & 924 may be similar to user profile 104 (shown in FIG. 1). In the exemplary embodiment, the each of the user profiles 920, 922, & 924 may include a plurality of user preferences and one or more usage characteristics, such as those captured by telematics computer device 330 (shown in FIG. 3). In the exemplary embodiment, user computer devices 914, 916, & 918 may transmit user profiles 920, 922, & 924 to IM server 310.

In the exemplary embodiment, IM server 310 may rank the insurance offers 908, 910, & 912 based upon the associated prices. For example, IM server 310 may compare the maximum price associated with each insurance offer 908, 910, & 912 for a first target usage characteristic. In this example, insurance offer C 912 may have the highest price, with insurance offer A 908 having the second highest. In the exemplary embodiment, IM server 310 may set the actual price to be just higher than that of the second highest price.

In the exemplary embodiment, IM server 310 may compare the plurality of user profiles 920, 922, & 924 to the plurality of insurance offers 908, 910, and 912. IM server 310 may determine which insurance offers 908, 910, & 912 match up with a user profile 920, 922, & 924. In some embodiments, IM server 310 may compare the coverage options of the insurance offers 908, 910, & 912 to the user preferences of the user profiles 920, 922, & 924. Once the IM server 310 has determined which insurance offers 908, 910, & 912 and user profiles 920, 922, & 924 match, IM server 310 may compare the rankings of the insurance offers 908, 910, & 912 to the associated prices. For example, IM server 310 may determine that insurance offers A 908 and C 912 match user profiles 920, 922, and 924.

In the exemplary embodiment, IM server 310 may transmit all three user profiles 920, 922, and 924 to insurance provider computer device C 906 because insurance offer C 912 has the highest price for target usage characteristic. In other embodiments, IM server 310 may determine that the actual price for all three user profiles 920, 922, and 924 exceeds the budget associated with insurance offer C 912. In these embodiments, IM server 310 may determine that the actual price for two insurance offers does not exceed the budget. IM server 310 may transmit two of the user profiles 920 and 924 to insurance provider computer device C 906. IM server 310 may then transmit the remaining user profile 922 to insurance provider computer device A 902 because insurance offer A has the second highest price for the first target usage characteristic.

In some embodiments, IM server 310 may consider multiple target usage characteristics and multiple associated prices. Furthermore, IM server 310 may consider multiple levels of target usage characteristics. In some embodiments, the price may be associated with a plurality of target usage characteristics and require that all of the target usage characteristics need to be present and/or at the appropriate levels to be worth the price.

In some embodiments, the insurance provider 112 associated with the offer 110 pays the actual price to the IM server 310 for each user profile 104. In other embodiments, the actual price may be paid to a third party for each user profile 104.

In some embodiments, insurance offers 908, 910, and 912 are stored in a blockchain structure. In some embodiments, each corresponding insurance provider computer device 902, 904, and 906 stores a blockchain for each offer 908, 910, and 912. In other embodiments, offers 908, 910, and 912 are stored in a single blockchain, where each offer 908, 910, and 912 is a different block. In some further embodiments, IM server 310 stores the matched offers 908, 910, and 912 and user profiles 920, 922, and 924 in blockchains for the corresponding offer 908, 910, and 912. For example, user profile B 922 may be stored in the blockchain for insurance offer A 908 and user profiles A 920 and user profile C 924 may be stored in the blockchain for insurance offer C 912.

In some embodiments, user profiles 920, 922, and 924 are stored in a blockchain structure. In some embodiments, each corresponding user computer device 914, 916, and 918 stores a blockchain for each user profile 920, 922, and 924. In other embodiments, user profiles 920, 922, and 924 are stored in a single blockchain, where each user profile 920, 922, and 924 is a different block.

### Exemplary Process for Matching Users to Insurance Providers

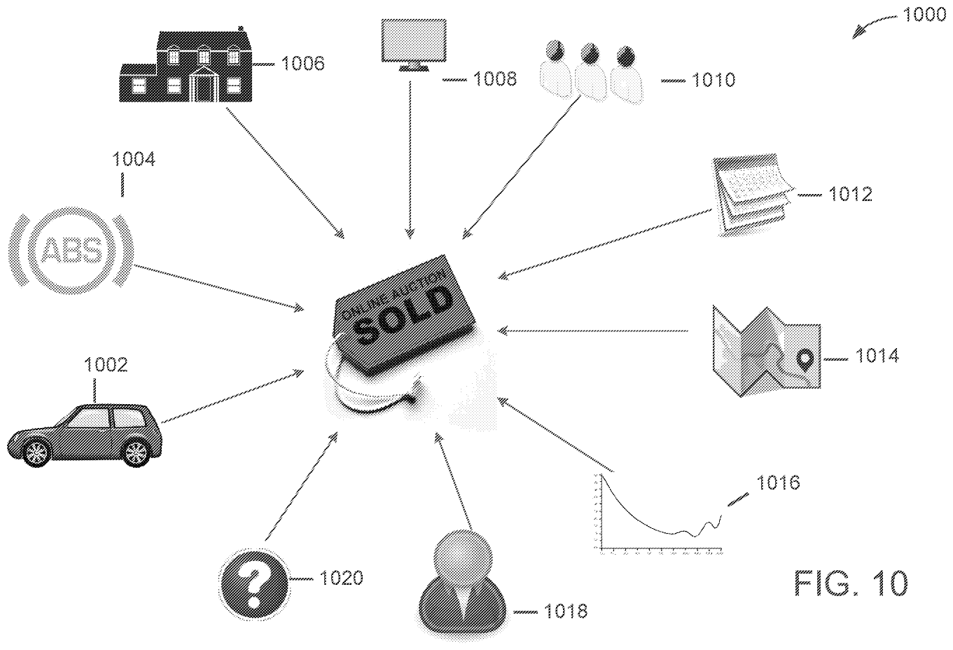

FIG. 10 illustrates a flow diagram of an exemplary process 1000 of matching users to insurance providers based upon user profiles and insurer bids as shown in FIG. 9 using system 300 (shown in FIG. 3). Process 1000 may be implemented by a computer device, for example insurance broker server 108 (shown in FIG. 1) or IM server 310 (shown in FIG. 3).

Process 1000 illustrates the data that may be collected and/or considered in matching user profiles 104 (shown in FIG. 1) to offers 110 (shown in FIG. 1), such as in process 900 (shown in FIG. 9). In the exemplary embodiment, some information may be provided in user profile 104. In other embodiments, some information may be provided by IM server 310 or telematics computer device 330 (shown in FIG. 3). In some embodiments, some information may be stored in a blockchain.

From the user profile 104 provided by user 102 (shown in FIG. 1), IM server 310 may collect the vehicle make, model, and year 1002 about a vehicle to be insured. From this and/or other information, IM server 310 may also be able to determine or retrieve safety information 1004 including the safety features and/or safety record of the vehicle. This safety information 1004 may include whether the vehicle is autonomous or semi-autonomous.

The types of autonomous or semi-autonomous vehicle-related functionality or technology that may be used with the present embodiments include and/or be related to the following types of functionality: (a) fully autonomous (driverless); (b) limited driver control; (c) vehicle-to-vehicle (V2V) wireless communication; (d) vehicle-to-infrastructure (and/or vice versa) wireless communication; (e) automatic or semi-automatic steering, acceleration, braking, collision warning, and/or blind spot monitoring; (f) adaptive cruise control; (g) automatic or semi-automatic parking/parking assistance and/or collision preparation (windows roll up, seat adjusts upright, brakes pre-charge, etc.); (h) driver acuity/alertness monitoring; (i) pedestrian detection; (j) autonomous or semi-autonomous backup systems; (k) road mapping or navigation systems; (l) software security and anti-hacking measures; (m) theft prevention/automatic return; (n) automatic or semi-automatic driving without occupants; and/or other functionality.

The adjustments to automobile insurance rates or premiums based upon the autonomous or semi-autonomous vehicle-related functionality or technology may take into account the impact of such functionality or technology on the likelihood of a vehicle accident or collision occurring. For instance, a processor may analyze historical accident information and/or test data involving vehicles having autonomous or semi-autonomous functionality. Factors that may be analyzed and/or accounted for that are related to insurance risk, accident information, or test data may include (1) point of impact; (2) type of road; (3) time of day; (4) weather conditions; (5) road construction; (6) type/length of trip; (7) vehicle style; (8) level of pedestrian traffic; (9) level of vehicle congestion; (10) atypical situations (such as manual traffic signaling); (11) availability of internet connection for the vehicle; and/or other factors. These types of factors may also be weighted according to historical accident information, predicted accidents, vehicle trends, test data, and/or other considerations.

From the user profile 104, IM server 310 may collect the size and/or age of a residence 1006 to be insured. IM server 310 may also receive and/or collect information about the contents 1008 of the residence. From the user profile, IM server 310 may collect information about individuals 1010 to be insured. This individual's information 1010 may include, but is not limited to, number, name(s), gender(s), and age(s) of one or more individual(s) to be covered.

The user profile 104 may also include one or more dates for coverage 1012 and/or the geographic location 1014 that coverage is for. In some embodiments, user profile 104 may include a usage profile, where the usage profile includes usage characteristics determined through telematics information 1016 received from telematics computer device 330.

In some embodiments, IM server 310 may also be able to collect actuarial data, underwriting characteristics, and any known history 1018 of user 102 or vehicle (such as in the case of an autonomous vehicle). For example, if user 102 had been pre-approved by one or more insurance providers 112 (shown in FIG. 1), the IM server 310 may have access to this preapproval data. The historical data of the user 102, the residence, the individuals, or the vehicle may also include telematics data, as discussed herein, such as sensor data collected by various sensors mounted on the vehicle or on a driver's or passenger's mobile device that detect various conditions of vehicle or residence including speed, acceleration, gear, braking, cornering, miles driven or operated, GPS location, locking habits, maintenance, and/or other conditions related to the operation of vehicle.

Other variables 1020 that are important to insurance providers 112 may also be collected as necessary to match offers 110 to user profiles 104. IM server 310 may analyze some or all of the above data to match the user profile 104 to one or more offers 110.

### Exemplary Computer-Implemented Method for Matching the Users to Insurance Providers

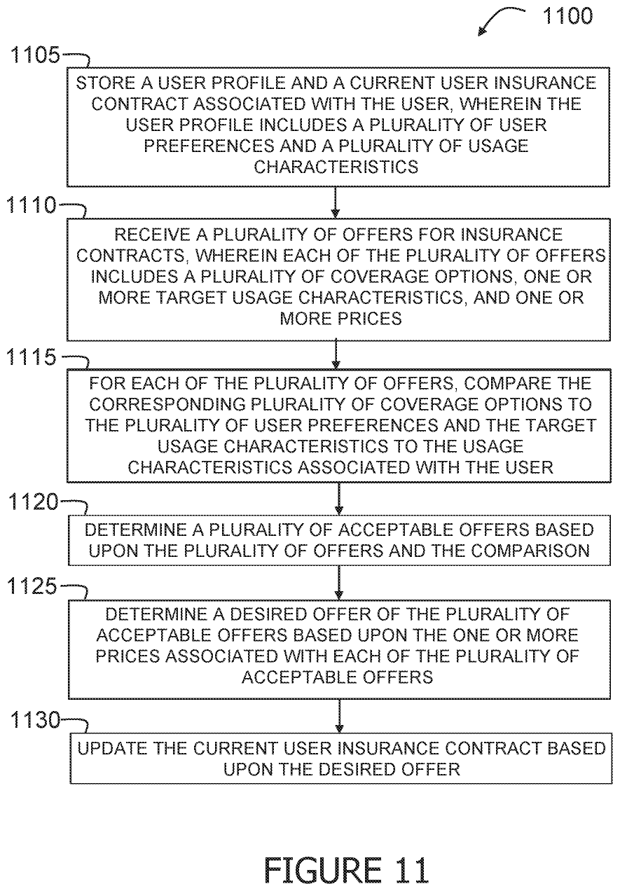

FIG. 11 illustrates a flow chart of an exemplary computer-implemented process 1100 for matching the users 102 to insurance providers 112 based upon user profiles 104 and insurer offers 110 (all shown in FIG. 1). Process 1100 may be implemented by a computing device, for example insurance broker server 108 (shown in FIG. 1) or IM server 310 (shown in FIG. 3). In the exemplary embodiment, IM server 310 may be in communication with a plurality of insurance provider computer devices 305 (shown in FIG. 3) or insurance provider computer devices 902, 904, & 906 (all shown in FIG. 9) and at least one user computer device 325 (shown in FIG. 3) or user computer devices 914, 916, and 918 (all shown in FIG. 9).

In the exemplary embodiment, IM server 310 may store 1105 a user profile 104 and a current user insurance contract 106 (shown in FIG. 1). In the exemplary embodiment, user profile 104 may include a plurality of user preferences, and current user insurance contract 106 may include a plurality of coverage options. In the exemplary embodiment, user profile 104 may also include a usage profile that includes a plurality of usage characteristics. The plurality of usage characteristics may be based upon telematics data associated with the user received from telematics computer device 330 (shown in FIG. 3). In the exemplary embodiment, IM server 310 may receive user profile 104 from user computer device 325.

In the exemplary embodiment, IM server 310 may receive 1110 a plurality of offers 110 from a plurality of insurance provider computer devices 305. Each of the offers 110 may include a plurality of coverage options, where each of the coverage options represents one or more details about an insurance contract associated with the offer 110. The offers 110 may also include one or more target usage characteristics and one or more prices associated with the target usage characteristics.

For each of the plurality of offers 110, IM server 310 may compare 1115 the corresponding plurality of coverage options to the corresponding plurality of user preferences in user profile 104. IM server 310 may also compare 1115 the target usage characteristics with the usage characteristics associated with the user 102.

IM server 310 may determine 1120 a plurality of acceptable offers 110 based upon the plurality of offers 110 and the comparison. In these embodiments, IM server 310 may determine that a plurality of offers 110 from a plurality of insurance providers 112 match the coverage options to the user preferences and the target usage characteristics with the usage characteristics. IM server 310 may determine 1125 a desired offer 110 of the plurality of acceptable offers 110 based upon the one or more prices associated with each of the plurality of acceptable offers. In some embodiments, IM server 310 may transmit the desired offer 110 to user computer device 325 for the user's approval. Once IM server 310 receives the user's 102 approval, IM server 310 may update 1130 the current user insurance contract 106 based upon the desired offer 110.

In the exemplary embodiment, IM server 310 may update 1130 the current user insurance contract 106 based upon the desired offer 110. IM server 310 may transmit approval of desired offer 110 to insurance provider computer device 305 including payment and other information from user profile 104 to put desired offer 110 in force as current user insurance contract 106.

In some embodiments, IM server 310 may determine an actual price for a first target usage characteristic based upon the plurality of offers 110. In these embodiments, IM server 310 may determine the actual price based upon the relative maximum prices associated with each offer 110. In some embodiments, IM server 310 may set the actual price to be higher than the second highest maximum price. IM server 310 may determine which insurance provider 112 is associated with the highest maximum price and determine 1125 that the offer 110 associated with that insurance provider 112 is the desired offer.

In some embodiments, IM server 310 may store a plurality of user profiles 104, such as user profiles 920, 922, & 924 (all shown in FIG. 9). In these embodiments, IM server 310 may compare the plurality of user profiles 104 to the first target characteristic to determine a plurality of target user profiles 104 that match up. In these embodiments, IM server 310 may transmit a plurality of matching user profiles 104 to insurance provider computer device 305 associated with the actual price. In some of these embodiments, IM server 310 charges the insurance provider 112 a fee equal to the actual price for each user profile 104 transmitted. In some further embodiments, each offer 110 may also include a budget. IM server 310 may determine a maximum number of target user profiles 104 based upon the actual price and the budget.

In some further embodiments, IM server 310 may determine a second actual price and an associated second insurance provider 112 for the first target characteristic. The second actual prices may be less than the actual price. IM server 310 may determine a second plurality of target user profiles 104 based upon the plurality of target user profiles 104 and the maximum number of target user profiles 104 for the first insurance provider 112. The IM server 310 may transmit the second plurality of target user profiles 104 to the associated second insurance provider 112.

In still further embodiments, IM server 310 may access telematics data associated with the user 102. In the exemplary embodiment, the telematics data includes at least one of speed data, acceleration data, braking data, location data, route data, navigation data, distance data, timing data, and duration data. IM server 310 may access the telematics data from a user computer device associated with the user (e.g., user computer device 325), and/or any other telematics computer device (e.g., telematics computer device 330). In some embodiments, IM server 310 may determine a device identifier of user computer device 325 associated with the user, and embed the device identifier into user profile 104. The device identifier may include any unique identifier, such as a phone number or a randomly generated alphanumeric identifier. In this way, IM server 310 may associate one or more user computer devices 325 with user profile 104, such that telematics data from user computer device 325 may be more easily identified as associated with the user. IM server 310 may then access the telematics data generated by the user computer device 325. In some embodiments, IM server 310 may communicatively couple to user computer device 325 (e.g., as shown in FIG. 3) and may retrieve the telematics data from the user computer device 325. In other embodiments (as also shown in FIG. 3), user computer device 325 may store telematics data at a database (e.g., database 320, shown in FIG. 3), and IM server 310 may retrieve the telematics data therefrom.

In other embodiments, IM server 310 may determine a device identifier of a vehicle computer device (e.g., vehicle controller 710, shown in FIG. 7) of a vehicle (e.g., vehicle 702, also shown in FIG. 7) associated with the user 102. The device identifier may include any unique identifier, such as a vehicle identification number (VIN), a phone number associated with telephonic capabilities or structure of the vehicle, or a randomly generated alphanumeric identifier. IM server 310 may embed the device identifier into user profile 104. IM server 310 may then access the telematics data generated by the vehicle computer device. In some embodiments, IM server 310 may communicatively couple to the vehicle computer device and may retrieve the telematics data from the vehicle computer device. In other embodiments the vehicle computer device may store telematics data at a database (e.g., database 320), and IM server 310 may retrieve the telematics data therefrom.

Based upon the telematics data, IM server 310 may generate a usage profile associated with the user. The usage profile may represent usage by the user 102 of a property intended to be covered by an insurance contract represented by an offer 110. The usage profile may include one or more usage characteristics. Usage characteristics may define or represent particular behaviors or variables exhibited (or not exhibited) by the user as they relate to the user's use of the property. In some embodiments, usage characteristics define risk/risky behaviors exhibited (or not exhibited) by the user. For instance, IM server 310 may analyze the telematics data according to a plurality of risk identification rules (e.g., rules 628, shown in FIG. 6) to identify particular behaviors evidenced by the telematics data, to thereby determine the one or more usage characteristics (e.g., a value that represents a level of risk associated with a behavior, such as driving speed, driving distance, driving time, etc.).

IM server 310 may associate the generated usage profile with the user profile 104. In other words, IM server 310 may update the user profile 104 with the usage profile, which may provide a more complete or at least a more detailed depiction of user 102 to insurance providers 112.

In some embodiments, where the telematics data initially accessed includes “first” telematics data, IM server 310 may access second (e.g., new or updated) telematics data, the second telematics data generated after the first telematics data. IM server 310 may also update one or more risk characteristics of the usage profile, based upon the second telematics data.

In some embodiments, user profile 104 may be stored in a blockchain structure. In these embodiments, changes to user profile 104 are updated as additional or new blocks in the blockchain. In some other embodiments, the usage profile including telematics data may be stored in a blockchain structure. In some of these embodiments, IM server 310 may process the telematics data to store updates to the usage profile in the blockchain. In other embodiments, IM server 310 or user computer device 325 may store telematics data directly in the usage profile blockchain.

In the exemplary embodiment, when user insurance contract 106 is updated 1130, IM server 310 updates the blockchains storing user insurance contract 106. In some embodiments, this update may be performed at the prime node (such as at IM server 310) and a new block is transmitted to the other nodes in the blockchain ledger. In other embodiments, information about the update may be transmitted to the other nodes in the blockchain ledger for them to create their own blocks. In some embodiments, IM server 310 or insurance provider 112 store the offers 110 in blockchains as well. In some embodiments, this update may include a plurality of offers 110 that were compared to user insurance contract 106. In other embodiments, the update may be a new block for the blockchain that includes a new insurance contract 106 from a different insurance provider 112 based on the desired offer.

In the exemplary embodiment, each user insurance contract 106 is stored in its own blockchain ledger. As the user insurance contract 106 is modified or additional information is added to the user insurance contract 106, such as telematics information, another block may be added to the blockchain of the user insurance contract 106. In some other embodiments, each offer 110 that is compared to user insurance contract 106 is also stored in the blockchain for that user insurance contract 106.

### Exemplary Method for Using Game-Based Telematics Data to Generate a Usage Profile

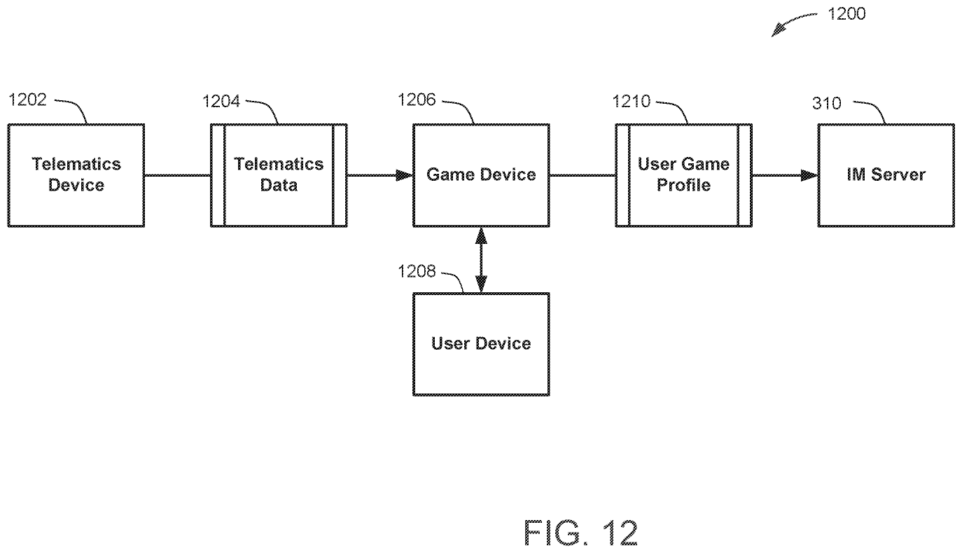

FIG. 12 illustrates a flow diagram of an exemplary computer-implemented process 1200 for using game-based telematics data to generate a usage profile for a user using system 300 (shown in FIG. 3).

In the exemplary embodiment, a user may be playing a telematics-based game. To play the game, a game device 1206 collects telematics data 1204 from a telematics device 1202. In the exemplary embodiment, telematics device 1202 may be similar to telematics computer device 330 (shown in FIG. 3), and/or may be dashboard plug-in device or a mobile device running a telematics app. In the exemplary embodiment, game device 1206 may be similar to game computer device 335 (shown in FIG. 3) (or may be the same of telematics device or mobile device mentioned above). For example, user may drive a vehicle on a trip, such as from home to work. During the trip, telematics device 1202 may collect telematics data 1204 about the trip. Telematics device 1202 may transmit the telematics data 1204 to game device 1206 (or otherwise transfer the telematics data to a gaming app running on a mobile device, a game device 1206, or the telematics device 1202).

In the exemplary embodiment, game device 1206 may receive the telematics data 1204 after the trip is complete. This may be considered a safety feature to prevent driver distraction. Game device 1206 may use the telematics data 1204 to determine one or more game resources that the user earned during the trip. For example, game device 1206 may determine that the user used his or her blinker at every turn during the trip and provide the user with game resources based upon this information. Game device 1206 may also provide game resources based upon other driving behavior, such as, but not limited to, speed in relation to the speed limit, number of sudden stops, average stopping distance, average tailing distance, complete stops at stop signs, and/or other driving behaviors.

The one or more game resources may include, but are not limited to, points, experience, trophies, badges, resources for building and/or buying items in the game, money, credits, coins, and/or other rewards. For example, the game may be a building game, where the user spends resources to purchase and/or build facilities in the game. As the user drives, the user earns these resources based upon the desired user driving behaviors as defined by the game. For example, one game may provide game resources based upon the distance driven. Another game may provide resources based upon one or more individual behaviors of the user during the trip, such as not exceeding the speed limit. In the exemplary embodiment, the game resources are earned based upon the driving behaviors of the user during the trip. The amount of resources associated with each behavior may depend on the thresholds and settings associated with each of the driving behaviors as defined by the game.

In the exemplary embodiment, game device 1206 may host the game and be in communication with a user device 1208 that user accesses the game on. In some embodiments, user device 1208 may be similar to user computer device 325 (shown in FIG. 3). Game device 1206 may transmit the one or more earned game resources to user device 1208 as a part of game play. The user may then instruct game device 1206 on how to spend or use those game resources. Furthermore, game device 1206 may generate a user game profile 1210 for the user based upon the telematics data 1204. For example, for each trip that user completes, game device 1206 receives telematics data 1204 about the trip. Game device 1206 then uses that data to both generate game resources and a user game profile 1210 associated with the user. In some embodiments, game device 1206 updates user game profile 1210 every time that game device 1206 receives telematics data 1204 about a trip. In some embodiments, user game profile 1210 includes all or a portion of the received telematics data 1204. In some other embodiments, user game profile 1210 does not include any telematics data 1204. In the exemplary embodiment, user game profile 1210 includes data about earned game resources and actions of the user in the game.

In the exemplary embodiment, game device 1206 transmits user game profile 1210 to IM server 310. IM server 310 may be able to determine one or more usage characteristics about user from user game profile 1210. For example, based upon the number of points earned in playing the game and the amount of time playing the game, IM server 310 may be able to determine the quality of the user's driving. In another example, IM server 310 may be able to determine that user did not exceed the speed limit for 10 days in a row, based upon an earned badge stored in the user game profile 1210. In some embodiments, IM server 310 generates a usage profile for user based upon the data in user game profile 1210. In some embodiments, IM server 310 may extract the usage data from the user game profile 1210 to generate a usage profile as described in process 800 (shown in FIG. 8).

In some further embodiments, IM server 310 matches the user game profile 1210 and/or usage profile to an existing user profile 104 and/or insurance contract 106 (both shown in FIG. 1). In some embodiment, IM server 310 may use the data in user game profile 1210 to match with one or more target usage characteristics in an offer 110 (shown in FIG. 1), such as described in process 1100 (shown in FIG. 11).

In another embodiment, a mobile device (e.g., smart phone) may have a telematics app stored thereof for collecting telematics data during vehicle movement, and may function as the telematics device 1202 mentioned above. The mobile device may also have a gaming app stored thereon for updating the user game profile 1210 using the telematics data collected, and may function similar to the game device 1206 mentioned above.

In some embodiments, user game profile 1210 may be stored in a blockchain structure. In these embodiments, changes to user game profile 1210 are updated as additional or new blocks in the blockchain. In some other embodiments, user game profile 1210 including telematics data may be stored in a blockchain structure. In some of these embodiments, game device 1206 may process the telematics data to store updates to the user game profile 1210 in the blockchain. In other embodiments, telematics device 1202 may store telematics data 1204 directly in the user game profile 1210 blockchain. In some of these embodiments, telematics device 1202 may store additional telematics data 1204 in the user game profile 1210 periodically. In some other embodiments, telematics device 1202 may store additional telematics data 1204 in the user game profile 1210 blockchain every time that user takes a trip or plays the game.

### Exemplary Computer-Implemented Method for Using Game-Based Telematics Data to Generate a Usage Profile

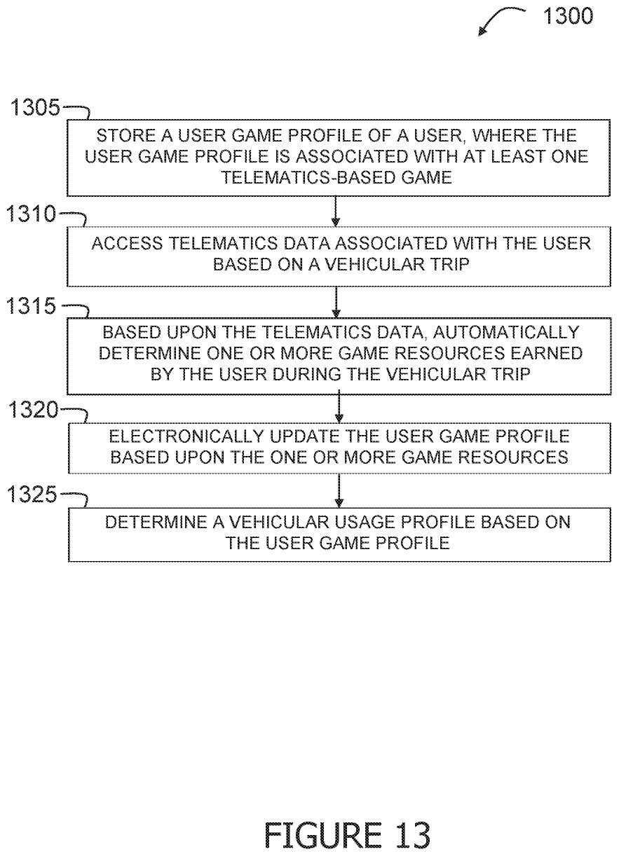

FIG. 13 illustrates a flow chart of an exemplary computer-implemented process 1300 for using game-based telematics data to generate a usage profile for a user using process 1200 (shown in FIG. 12). Process 1300 may be implemented by a computing device, for example insurance broker server 108 (shown in FIG. 1), IM server 310 (shown in FIG. 3), game computer device 335 (shown in FIG. 3), and/or game device 1206 (shown in FIG. 12). In the exemplary embodiment, IM server 310 may be in communication with a plurality of insurance provider computer devices 305 (shown in FIG. 3) or insurance provider computer devices 902, 904, & 906 (all shown in FIG. 9), at least one user computer device 325 (shown in FIG. 3) or user computer devices 914, 916, and 918 (all shown in FIG. 9), at least one game device 1206 or game computer device 335, and at least one telematics computer device 330 (shown in FIG. 3) or telematics device 1202 (shown in FIG. 12), such as a vehicle computer device (e.g., vehicle controller 710, shown in FIG. 7).

In the exemplary embodiment, game device 1206 may store 1305 a user game profile 1210 (shown in FIG. 12) of a user. The user game profile 1210 is associated with at least one telematics-based game. The telematics-based game is played based upon telematics data 1204 (shown in FIG. 12). The user game profile 1210 may include a plurality of information about the user and the user's interactions with the game. In some embodiments, user game profile 1210 may include a plurality of telematics data 1204. In some embodiment, user game profile 1210 may only include a portion of the telematics data 1204 received.

In the exemplary embodiment, game device 1206 may access 1310 telematics data 1204 associated with the user based upon a vehicular trip. In the exemplary embodiment, the telematics data 1204 includes at least one of speed data, acceleration data, braking data, location data, route data, navigation data, distance data, timing data, and duration data. Game device 1206 may access 1310 the telematics data 1204 from a user computer device associated with the user (e.g., user computer device 325), and/or any other telematics computer device (e.g., telematics computer device 330).

In some embodiments, game device 1206 may determine a device identifier of user computer device 325 associated with the user, and embed the device identifier into user game profile 1210. The device identifier may include any unique identifier, such as a phone number or a randomly generated alphanumeric identifier. In this way, game device 1206 may associate one or more user computer devices 325 with user game profile 1210, such that telematics data from user computer device 325 may be more easily identified as associated with the user. Game device 1206 may then access 1310 the telematics data 1204 generated by the user computer device 325. In some embodiments, game device 1206 may communicatively couple to user computer device 325 (e.g., as shown in FIG. 3) and may retrieve the telematics data 1204 from the user computer device 325. In other embodiments (as also shown in FIG. 3), user computer device 325 may store telematics data 1204 at a database (e.g., database 320, shown in FIG. 3), and game device 1206 may retrieve the telematics data 1204 therefrom.

In other embodiments, game device 1206 may determine a device identifier of a vehicle computer device (e.g., vehicle controller 710, shown in FIG. 7) of a vehicle (e.g., vehicle 702, also shown in FIG. 7) associated with the user. The device identifier may include any unique identifier, such as a vehicle identification number (VIN), a phone number associated with telephonic capabilities or structure of the vehicle, or a randomly generated alphanumeric identifier. Game device 1206 may embed the device identifier into user game profile 1210. Game device 1206 may then access 1310 the telematics data 1204 generated by the vehicle computer device. In some embodiments, game device 1206 may communicatively couple to the vehicle computer device and may retrieve the telematics data 1204 from the vehicle computer device. In other embodiments the vehicle computer device may store telematics data 1204 at a database (e.g., database 320), and game device 1206 may retrieve the telematics data 1204 therefrom.

In the exemplary embodiment, based upon the telematics data 1204, game device 1206 automatically determines 1315 one or more game resources earned by the user during the vehicular trip. As described above, the one or more game resources may include, but are not limited to, points, experience, trophies, badges, resources for building and/or buying items in the game, money, credits, coins, and/or other rewards.

In the exemplary embodiment, game device 1206 electronically may update 1320 the user game profile 1210 based upon the one or more game resources. In the exemplary embodiment, game device 1206 transmits the one or more earned game resources to user device 1210 for display to the user, so that the user may use those resources in the game. In other embodiments, the user is merely notified of the earned game resources. In the exemplary embodiment, game device 1206 transmits the earned game resources after the trip is over to prevent and/or limit driver distraction. In the exemplary embodiment, the game resources are earned based upon the driving behaviors of the user during the trip. The amount of resources associated with each behavior may depend on the thresholds and settings associated with each of the driving behaviors as defined by the game.

In the exemplary embodiment, game device 1206 or IM server 310 may determine 1325 a vehicle usage profile based upon the user game profile 1210. The vehicle usage profile may include one or more usage characteristics. Usage characteristics may define or represent particular behaviors or variables exhibited (or not exhibited) by the user as they relate to the user's use of the vehicle. In some embodiments, usage characteristics define risk/risky behaviors exhibited (or not exhibited) by the user. For instance, IM server 310 may analyze the user game profile 1210 according to a plurality of risk identification rules (e.g., rules 628, shown in FIG. 6) to identify particular behaviors evidenced by the user game profile 1210 as it relates to the telematics data 1204, to thereby determine the one or more usage characteristics (e.g., a value that represents a level of risk associated with a behavior, such as driving speed, driving distance, driving time, etc.).

In some further embodiments, IM server 310 may determines a rating of the user based upon the user game profile 1210. For example, IM server 310 may rate the user in proportion to the score or level of the user and the amount of time played. In other examples, IM server 310 may receive a plurality of data in user game profile 1210 and assign a value to different portions of the plurality of data. In this example, IM server 310 may calculate the user rating based upon the plurality of values. In these embodiments, the user rating may represent an overall driving pattern of the user. In some further embodiments, IM server 310 may rank the user in relation to other users based upon the determined rating.

In some embodiments, IM server 310 may associate the generated vehicle usage profile with the user profile 104 (shown in FIG. 1). In other words, IM server 310 may update the user profile 104 with the usage profile, which may provide a more complete or at least a more detailed depiction of user 102 to insurance providers 112 (both shown in FIG. 1).

In some embodiments, IM server 310 may use the updated user profile 104 in process 200 (shown in FIG. 2), process 800 (shown in FIG. 8), and/or process 1100 (shown in FIG. 11) to update a user insurance contract 106 (shown in FIG. 1). For example, IM server 310 may receive a plurality of offers 110 (shown in FIG. 1) for insurance contracts. Each of the plurality of offers 110 may include a plurality of coverage options and one or more target usage characteristics. For each of the plurality of offers 110, IM server 310 may compare the corresponding plurality of coverage options to the plurality of user preferences, and the one or more target usage characteristics to one or more usage characteristics in the vehicular usage profile associated with the user. In some embodiments, multiple vehicles may be associated with the same user and the game.

In some embodiments, where the telematics data 1204 initially accessed includes “first” telematics data, game device 1206 may access second (e.g., new or updated) telematics data, the second telematics data generated after the first telematics data. IM server 310 or game device 1206 may also update one or more risk characteristics of the vehicular usage profile, based upon the second telematics data.

### Exemplary Embodiments & Functionality

In one aspect, a computer system for generating and managing usage-based insurance contracts may be provided. The computer system may include at least one processor in communication with at least one memory device. The at least one processor may be configured or programmed to: (1) store a user profile and a current user insurance contract, wherein the user profile includes a plurality of user preferences, (2) receive a plurality of offers for insurance contracts from a plurality of insurance providers, wherein each of the plurality of offers includes a plurality of coverage options, (3) for each of the plurality of offers, compare the corresponding plurality of coverage options to the plurality of user preferences, (4) automatically determine a desired offer of the plurality of offers based upon the comparison, and/or (5) electronically update the current user insurance contract based upon the desired offer. The system may include additional, less, or alternate functionality, including that discussed elsewhere herein.

In another aspect, a computer system for generating and managing usage-based insurance contracts and using telematics data to build a user profile may be provided. The computer system may include at least one processor in communication with at least one memory device. The at least one processor may be configured or programmed to: (1) store a user profile of a user and a current user insurance contract associated with the user, wherein the user profile includes a plurality of user preferences, (2) access telematics data associated with the user, (3) based upon the telematics data, generate a usage profile associated with the user, the usage profile including one or more usage characteristics, (4) associate the generated usage profile with the user profile, (5) receive a plurality of offers for insurance contracts from a plurality of insurance providers, wherein each of the plurality of offers includes a plurality of coverage options and one or more target usage characteristics, (6) for each of the plurality of offers, compare the corresponding plurality of coverage options to the plurality of user preferences and the one or more target usage characteristics to the one or more usage characteristics associated with the user, (7) automatically determine a desired offer of the plurality of offers based upon the comparison, and/or (8) electronically update the current user insurance contract based upon the desired offer. The system may include additional, less, or alternate functionality, including that discussed elsewhere herein.

In some embodiments, the at least one processor may be further programmed to: (a) determine a device identifier of a user computer device associated with the user; (b) embed the device identifier into the user profile; and/or (c) access the telematics data generated by the user computer device. The at least one processor may be further programmed to: (d) communicatively couple to the user computer device; and/or (e) retrieve the telematics data from the user computer device.

In some embodiments, the at least one processor may be further programmed to: (a) determine a device identifier of a vehicle computer device of a vehicle associated with the user; (b) embed the device identifier into the user profile; and/or (c) access the telematics data generated by the vehicle computer device. The at least one processor may be further programmed to: (d) communicatively couple to the vehicle computer device; and/or (e) retrieve the telematics data from the vehicle computer device. The telematics data may include at least one of speed data, acceleration data, braking data, location data, route data, navigation data, distance data, timing data, and duration data, and wherein the at least one processor is further programmed to analyze the telematics data according to a plurality of usage identification rules to determine the one or more usage characteristics.

In some embodiments, the telematics data may include first telematics data, and wherein the at least one processor may be further programmed to: (a) access second telematics data, the second telematics data generated after the first telematics data; and/or (b) update one or more usage characteristics of the usage profile based upon the second telematics data.

In a further aspect, a computer-based method for managing insurance contracts using telematics data to build a user profile may be provided. The method may be implemented on an insurance management (“TM”) computer device including at least one processor in communication with at least one memory device. The method may include: (i) storing, in the memory device, the user profile of a user and a current user insurance contract associated with the user, wherein the user profile includes a plurality of user preferences; (ii) accessing telematics data associated with the user; (iii) based upon the telematics data, generating a usage profile associated with the user, the usage profile including one or more usage characteristics; (iv) associating the generated usage profile with the user profile; (v) receiving a plurality of offers for insurance contracts from a plurality of insurance providers, wherein each of the plurality of offers includes a plurality of coverage options and one or more target usage characteristics; (vi) for each of the plurality of offers, comparing the corresponding plurality of coverage options to the plurality of user preferences and the one or more target usage characteristics to the one or more usage characteristics associated with the user; (vii) automatically determining a desired offer of the plurality of offers based upon the comparison; and/or (viii) electronically updating the current user insurance contract based upon the desired offer.

In some embodiments, accessing telematics data may include: (a) determining a device identifier of a user computer device associated with the user; (b) embedding the device identifier into the user profile; and/or (c) accessing the telematics data generated by the user computer device. Accessing the telematics data may further include: (d) communicatively coupling to the user computer device; and/or (e) retrieving the telematics data from the user computer device.

In some embodiments, accessing telematics data may include: (a) determining a device identifier of a vehicle computer device of a vehicle associated with the user; (b) embedding the device identifier into the user profile; and/or (c) accessing the telematics data generated by the vehicle computer device. Accessing the telematics data may further include: (d) communicatively coupling to the vehicle computer device; and/or (e) retrieving the telematics data from the vehicle computer device. Accessing the telematics data may include accessing at least one of speed data, acceleration data, braking data, location data, route data, navigation data, distance data, timing data, and duration data, and the method may further include analyzing the telematics data according to a plurality of usage identification rules to determine the one or more usage characteristics.

In some embodiments, the telematics data may include first telematics data, and the method may further include: (a) accessing second telematics data, the second telematics data generated after the first telematics data; and/or (b) updating one or more usage characteristics of the usage profile based upon the second telematics data.

In another aspect, at least one non-transitory computer-readable storage medium having computer-executable instructions embodied thereon may be provided. When executed by at least one processor, the computer-executable instructions may cause the processor to: (i) store a user profile of a user and a current user insurance contract associated with the user, wherein the user profile includes a plurality of user preferences; (ii) access telematics data associated with the user; (iii) based upon the telematics data, generate a usage profile associated with the user, the usage profile including one or more usage characteristics; (iv) associate the generated usage profile with the user profile; (v) receive a plurality of offers for insurance contracts from a plurality of insurance providers, wherein each of the plurality of offers includes a plurality of coverage options and one or more target usage characteristics; (vi) for each of the plurality of offers, compare the corresponding plurality of coverage options to the plurality of user preferences and the one or more target usage characteristics to the one or more usage characteristics associated with the user; (vii) automatically determine a desired offer of the plurality of offers based upon the comparison; and/or (viii) electronically update the current user insurance contract based upon the desired offer.

In some embodiments, the computer-executable instructions may further cause the processor to: (a) determine a device identifier of a user computer device associated with the user; (b) embed the device identifier into the user profile; and/or (c) access the telematics data generated by the user computer device. The computer-executable instructions may further cause the processor to: (c) communicatively couple to the user computer device; and/or (d) retrieve the telematics data from the user computer device.

In some embodiments, the computer-executable instructions may further cause the processor to: (a) determine a device identifier of a vehicle computer device of a vehicle associated with the user; (b) embed the device identifier into the user profile; and/or (c) access the telematics data generated by the vehicle computer device. The computer-executable instructions may further cause the processor to: (d) communicatively couple to the vehicle computer device; and/or (e) retrieve the telematics data from the vehicle computer device. The telematics data may include at least one of speed data, acceleration data, braking data, location data, route data, navigation data, distance data, timing data, and duration data, and the computer-executable instructions may further cause the processor to analyze the telematics data according to a plurality of usage identification rules to determine the one or more usage characteristics.

In some embodiments, the telematics data may include first telematics data, and the computer-executable instructions may further cause the processor to: (a) access second telematics data, the second telematics data generated after the first telematics data; and/or (b) update one or more usage characteristics of the usage profile based upon the second telematics data.

In still another aspect, a computer system for managing insurance contracts is provided. The computer system may include at least one processor in communication with at least one memory device. The at least one processor may be programmed to (1) store a user profile of a user and a current user insurance contract associated with the user. The user profile includes a plurality of user preferences and a usage profile including one or more usage characteristics. The at least one processor may also be programmed to (2) receive a plurality of offers for insurance contracts from a plurality of insurance providers. Each of the plurality of offers may include a plurality of coverage options, one or more target usage characteristics, and one or more prices associated with the one or more target usage characteristics. For each of the plurality of offers, the at least one processor may be further programmed to (3) compare the corresponding plurality of coverage options to the plurality of user preferences and the one or more target usage characteristics to the one or more usage characteristics associated with the user. Moreover, the at least one processor is programmed to: (4) automatically determine a plurality of acceptable offers based upon the plurality of offers and the comparison, (5) automatically determine a desired offer of the plurality of acceptable offers based upon the one or more prices associated with each of the plurality of acceptable offers, and/or (6) electronically update the current user insurance contract based upon the desired offer. The system may include additional, less, or alternate functionality, including that discussed elsewhere herein.

In yet another aspect, a computer system for using game-based telematics data to generate a usage profile for a user may be provided. The computer system may include at least one processor in communication with at least one memory device. The at least one processor may be programmed to (1) store a user game profile of a user where the user game profile is associated with a telematics-based game, (2) access telematics data associated with the user based upon a vehicular trip, (3) automatically determine one or more game resources earned by the user during the vehicular trip based upon the telematics data, (4) electronically update the user game profile based upon the one or more game resources, and/or (5) determine a vehicular usage profile based upon the user game profile. The computer system may have additional, less, or alternate functionality, including that discussed elsewhere herein.

In another aspect, a computer system for generating and managing usage-based insurance contracts may be provided. The computer system may include at least one processor in communication with at least one memory device. The at least one processor may be configured or programmed to: (1) store a user profile and a current user insurance contract, wherein the user profile includes a plurality of user preferences, wherein the user profile and the current user insurance contract are stored in a blockchain structure, (2) receive a plurality of offers for insurance contracts from a plurality of insurance providers, wherein each of the plurality of offers includes a plurality of coverage options, (3) for each of the plurality of offers, compare the corresponding plurality of coverage options to the plurality of user preferences, (4) automatically determine a desired offer of the plurality of offers based upon the comparison, (5) electronically update the current user insurance contract based upon the desired offer, and/or (6) store the updated current user insurance contract in a new block in the current user insurance contract blockchain. The system may include additional, less, or alternate functionality, including that discussed elsewhere herein.

In another aspect, a computer system for generating and managing usage-based insurance contracts and using telematics data to build a user profile may be provided. The computer system may include at least one processor in communication with at least one memory device. The at least one processor may be configured or programmed to: (1) store a user profile of a user and a current user insurance contract associated with the user, wherein the user profile includes a plurality of user preferences, wherein the user profile and the current user insurance contract are stored in a blockchain structure, (2) access telematics data associated with the user, (3) based upon the telematics data, generate a usage profile associated with the user, the usage profile including one or more usage characteristics, (4) associate the generated usage profile with the user profile, (5) store the usage profile in a block in the current user insurance contract blockchain; (6) receive a plurality of offers for insurance contracts from a plurality of insurance providers, wherein each of the plurality of offers includes a plurality of coverage options and one or more target usage characteristics, (7) for each of the plurality of offers, compare the corresponding plurality of coverage options to the plurality of user preferences and the one or more target usage characteristics to the one or more usage characteristics associated with the user, (8) automatically determine a desired offer of the plurality of offers based upon the comparison, (9) electronically update the current user insurance contract based upon the desired offer, and/or (10) store the updated current user insurance contract in a new block in the current user insurance contract blockchain. The system may include additional, less, or alternate functionality, including that discussed elsewhere herein.

### Machine Learning & Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may employ artificial intelligence and/or be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as image, mobile device, vehicle telematics, autonomous vehicle, and/or intelligent home telematics data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. In one embodiment, machine learning techniques may be used to extract data about the computer device, the user of the computer device, driver and/or vehicle, home owner and/or home, buyer, geolocation information, image data, home sensor data, and/or other data.

Based upon these analyses, the processing element may learn how to identify characteristics and patterns that may then be applied to analyzing sensor data, authentication data, image data, mobile device data, and/or other data. For example, the processing element may learn, with the user's permission or affirmative consent, to predict suggestions for offers to present to user and/or offers that processing device may switch to without specifically requesting permission from the user. The processing element may also learn how to identify different types of problems and/or issues with offers to assist the user with choosing which offer to select.

### Exemplary Mobile Device Embodiments

In one aspect, a mobile device configured to gamify a driving experience using telematics data may be provided. The mobile device may include at least one processor in communication with at least one memory device. The at least one processor may be programmed to: (1) store a user game profile of a user, wherein the user game profile is associated with at least one telematics-based game; (2) access telematics data associated with the user based upon a vehicular trip; (3) based upon the telematics data, automatically determine one or more game resources earned by the user during the vehicular trip; and/or (4) electronically update the user game profile based upon the one or more game resources to facilitate using telematics data in a gaming platform. The mobile device may include additional, less, or alternate functionality, including that discussed elsewhere herein.

In another aspect, a mobile device configured to gamify a driving experience using telematics data may be provided. The mobile device may include at least one processor in communication with at least one memory device. The at least one memory device having a telematics app or “App” (Application) configured to collect telematics data (e.g., speed, braking, cornering, heading, route, and other telematics data) stored thereon, the at least one processor may be programmed to: (1) collect telematics data during vehicle usage, such as via the telematics app stored on the at least one memory device; (2) execute a gaming app stored on the at least one memory device after a vehicular trip, the gaming app accessing the telematics data associated with, or collected during, one or more vehicular trips; (3) based upon the telematics data automatically determine one or more game resources earned by the user during the one or more vehicular trips; and/or (4) electronically update a user game profile based upon the one or more game resources to facilitate using telematics data in a gaming platform. The mobile device may include additional, less, or alternate functionality, including that discussed elsewhere herein.

In another aspect, a mobile device configured to gamify a driving experience using telematics data may be provided. The mobile device may include at least one processor in communication with at least one memory device. The at least one memory device having a telematics app configured to collect telematics data stored thereon, the at least one processor may be programmed to: (1) collect telematics data during vehicle usage, such as via the telematics app stored on the at least one memory device; (2) access or retrieve from the at least one memory device the telematics data associated with, or collected during, one or more vehicular trips; (3) based upon the telematics data, automatically determine one or more game resources earned by the user during the one or more vehicular trips; and/or (4) electronically update a user game profile based upon the one or more game resources to facilitate using telematics data in a gaming platform. The mobile device may include additional, less, or alternate functionality, including that discussed elsewhere herein.

In another aspect, a computer-implemented method of gamifying a driving experience using telematics data may be provided. The method may include (1) storing, via one or more processors (and/or via a mobile device), a user game profile of a user on a memory unit, wherein the user game profile is associated with at least one telematics-based game; (2) accessing, via the one or more processors, telematics data associated with the user based upon a vehicular trip, the telematics data being stored on the memory unit; (3) based upon the telematics data, automatically determining, via the one or more processors, one or more game resources earned by the user during the vehicular trip; and/or (4) electronically updating, via the one or more processors, the user game profile based upon the one or more game resources to facilitate using telematics data in a gaming platform. The method may include additional, less, or alternate actions, including those discussed elsewhere herein.

In another aspect, a computer-implemented method of gamifying a driving experience using telematics data may be provided. The method may include (1) collecting, via one or more processors and/or sensors, telematics data during vehicle usage, such as via a telematics app stored on at least one memory device; (2) executing, via the one or more processors, a gaming app stored on the at least one memory device after a vehicular trip, the gaming app accessing the telematics data associated with, or collected during, one or more vehicular trips; (3) based upon the telematics data, automatically determining, via the one or more processors and/or the gaming app, one or more game resources earned by the user during the one or more vehicular trips; and/or (4) electronically updating, via the one or more processors and/or gaming app, a user game profile based upon the one or more game resources to facilitate using telematics data in a gaming platform. The method may include additional, less, or alternate actions, including those discussed elsewhere herein.

In another aspect, a computer-implemented method of gamifying a driving experience using telematics data may be provided. The method may include (1) collecting, via one or more processors and/or sensors, telematics data during vehicle usage, such as via a telematics app stored on the at least one memory device; (2) accessing or retrieving, via the one or more processors, from the at least one memory device the telematics data associated with, or collected during, one or more vehicular trips; (3) based upon the telematics data, automatically determining, via the one or more processors, one or more game resources earned by the user during the one or more vehicular trips; and/or (4) electronically updating, via the one or more processors, a user game profile based upon the one or more game resources to facilitate using telematics data in a gaming platform. The telematics data may include the telematics data discussed herein, and at least one of speed data, acceleration data, braking data, location data, route data, navigation data, distance data, timing data, and duration data. The one or more game resources may include points or rewards, and/or auto or other types of insurance discounts. The method may include additional, less, or alternate actions, including those discussed elsewhere herein.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an exemplary embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality.

In some embodiments, the system includes multiple components distributed among a plurality of computer devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present embodiments may enhance the functionality and functioning of computers and/or computer systems.

As used herein, an element or step recited in the singular and preceded by the word “a” or “an” should be understood as not excluding plural elements or steps, unless such exclusion is explicitly recited. Furthermore, references to “example embodiment,” “exemplary embodiment,” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A computer system for managing insurance contracts, the computer system including at least one processor in communication with at least one memory device, the at least one processor programmed to:
store a user profile of a user and a current user insurance contract associated with the user, wherein the user profile includes a plurality of user preferences, wherein the user profile and the current user insurance contract are stored in a blockchain structure;
access telematics data associated with the user;
based upon the telematics data, generate a usage profile associated with the user, the usage profile including one or more usage characteristics;
associate the generated usage profile with the user profile;
store the usage profile in a block in the current user insurance contract blockchain;
receive a plurality of offers for insurance contracts from a plurality of insurance providers, wherein each of the plurality of offers includes a plurality of coverage options and one or more target usage characteristics;
for each of the plurality of offers, compare the corresponding plurality of coverage options to the plurality of user preferences and the one or more target usage characteristics to the one or more usage characteristics associated with the user;
automatically determine a desired offer of the plurality of offers based upon the comparison;
electronically update the current user insurance contract based upon the desired offer; and
store the updated current user insurance contract in a new block in the current user insurance contract blockchain.

2. The computer system of claim 1, wherein the at least one processor is further programmed to:
determine a device identifier of a user computer device associated with the user;
embed the device identifier into the user profile;
access the telematics data generated by the user computer device; and
store the telematics data in a block in the current user insurance contract blockchain.

3. The computer system of claim 2, wherein the at least one processor is further programmed to:
communicatively couple to the user computer device; and
retrieve the telematics data from the user computer device.

4. The computer system of claim 1, wherein the at least one processor is further programmed to:
determine a device identifier of a vehicle computer device of a vehicle associated with the user;
embed the device identifier into the user profile;
access the telematics data generated by the vehicle computer device; and
store the telematics data in a block in the current user insurance contract blockchain.

5. The computer system of claim 4, wherein the at least one processor is further programmed to:
communicatively couple to the vehicle computer device; and
retrieve the telematics data from the vehicle computer device.

6. The computer system of claim 4, wherein the telematics data includes at least one of speed data, acceleration data, braking data, location data, route data, navigation data, distance data, timing data, and duration data, and wherein the at least one processor is further programmed to analyze the telematics data according to a plurality of usage identification rules to determine the one or more usage characteristics.

7. The computer system of claim 1, wherein the telematics data includes first telematics data, and wherein the at least one processor is further programmed to:
access second telematics data, the second telematics data generated after the first telematics data;
update one or more usage characteristics of the usage profile based upon the second telematics data; and
store the updated usage profile in a block in the current user insurance contract blockchain.

8. A computer-based method for managing insurance contracts using telematics data to build a user profile, the method implemented on an insurance management (“IM”) computer device including at least one processor in communication with at least one memory device, the method comprising:
storing, in the memory device, the user profile of a user and a current user insurance contract associated with the user, wherein the user profile includes a plurality of user preferences, wherein the user profile and the current user insurance contract are stored in a blockchain structure;
accessing telematics data associated with the user;
based upon the telematics data, generating a usage profile associated with the user, the usage profile including one or more usage characteristics;
associating the generated usage profile with the user profile;
storing the usage profile in a block in the current user insurance contract blockchain;
receiving a plurality of offers for insurance contracts from a plurality of insurance providers, wherein each of the plurality of offers includes a plurality of coverage options and one or more target usage characteristics;
for each of the plurality of offers, comparing the corresponding plurality of coverage options to the plurality of user preferences and the one or more target usage characteristics to the one or more usage characteristics associated with the user;
automatically determining a desired offer of the plurality of offers based upon the comparison;
electronically updating the current user insurance contract based upon the desired offer; and
storing the updated current user insurance contract in a new block in the current user insurance contract blockchain.

9. The method of claim 8, wherein accessing telematics data comprises:
determining a device identifier of a user computer device associated with the user;
embedding the device identifier into the user profile;
accessing the telematics data generated by the user computer device; and
storing the telematics data in a block in the current user insurance contract blockchain.

10. The method of claim 9, wherein accessing the telematics data further comprises:
communicatively coupling to the user computer device; and
retrieving the telematics data from the user computer device.

11. The method of claim 8, wherein accessing telematics data comprises:
determining a device identifier of a vehicle computer device of a vehicle associated with the user;
embedding the device identifier into the user profile;
accessing the telematics data generated by the vehicle computer device; and
storing the telematics data in a block in the current user insurance contract blockchain.

12. The method of claim 11, wherein accessing the telematics data further comprises:
communicatively coupling to the vehicle computer device; and
retrieving the telematics data from the vehicle computer device.

13. The method of claim 11, wherein accessing the telematics data further comprises accessing at least one of speed data, acceleration data, braking data, location data, route data, navigation data, distance data, timing data, and duration data, the method further comprising analyzing the telematics data according to a plurality of usage identification rules to determine the one or more usage characteristics.

14. The method of claim 8, wherein the telematics data includes first telematics data, and wherein the method further comprises:
accessing second telematics data, the second telematics data generated after the first telematics data;
updating one or more usage characteristics of the usage profile based upon the second telematics data; and
storing the updated usage profile in a block in the current user insurance contract blockchain.

15. At least one non-transitory computer-readable storage medium having computer-executable instructions embodied thereon, wherein when executed by at least one processor, the computer-executable instructions cause the processor to:
store a user profile of a user and a current user insurance contract associated with the user, wherein the user profile includes a plurality of user preferences, wherein the user profile and the current user insurance contract are stored in a blockchain structure;
access telematics data associated with the user;
based upon the telematics data, generate a usage profile associated with the user, the usage profile including one or more usage characteristics;
associate the generated usage profile with the user profile;
store the usage profile in a block in the current user insurance contract blockchain;
receive a plurality of offers for insurance contracts from a plurality of insurance providers, wherein each of the plurality of offers includes a plurality of coverage options and one or more target usage characteristics;
for each of the plurality of offers, compare the corresponding plurality of coverage options to the plurality of user preferences and the one or more target usage characteristics to the one or more usage characteristics associated with the user;
automatically determine a desired offer of the plurality of offers based upon the comparison;
electronically update the current user insurance contract based upon the desired offer; and
store the updated current user insurance contract in a new block in the current user insurance contract blockchain.

16. The non-transitory storage medium of claim 15, wherein the computer-executable instructions further cause the processor to:
determine a device identifier of a user computer device associated with the user;
embed the device identifier into the user profile;
access the telematics data generated by the user computer device; and
store the telematics data in a block in the current user insurance contract blockchain.

17. The non-transitory storage medium of claim 16, wherein the computer-executable instructions further cause the processor to:
communicatively couple to the user computer device; and
retrieve the telematics data from the user computer device.

18. The non-transitory storage medium of claim 15, wherein the computer-executable instructions further cause the processor to:
determine a device identifier of a vehicle computer device of a vehicle associated with the user;
embed the device identifier into the user profile;
access the telematics data generated by the vehicle computer device; and
store the telematics data in a block in the current user insurance contract blockchain.

19. The non-transitory storage medium of claim 18, wherein the computer-executable instructions further cause the processor to:
communicatively couple to the vehicle computer device; and
retrieve the telematics data from the vehicle computer device.

20. The non-transitory storage medium of claim 18, wherein the telematics data includes at least one of speed data, acceleration data, braking data, location data, route data, navigation data, distance data, timing data, and duration data, and wherein the computer-executable instructions further cause the processor to analyze the telematics data according to a plurality of usage identification rules to determine the one or more usage characteristics.
